(19) United States
(12) Patent Application Publication
(10) Pub. No.: US 2004/0243364 A1
(43) Pub. Date: Dec. 2, 2004

(54) Method and system for modeling solar optics

(76) Inventors: Timothy J. Wendelin, Lakewood, CO (US); Gary J. Jorgensen, Pine, CO (US)

Correspondence Address: PAUL J WHITE, SENIOR COUNSEL, NATIONAL RENEWABLE ENERGY LABORATORY (NREL), 1617 COLE BOULEVARD, GOLDEN, CO, 80401-3393, US

(21) Appl. No.: 10/496,598

(22) PCT Filed: May 22, 2002
(86) PCT No.: PCT/US02/16271

(51) Int. Cl. G06F 17/10

(52) U.S. Cl. 703/2

(57) ABSTRACT

System and method of modeling optical systems (339). Experimental data representative of exisitng systems may be used for ray-tracing exisitng optical system. Generalized models may be developed to model multiple stages having multiple elements in an optical system. Graphical user interfaces enable generalized model parameter entry, model execution (420), model editing, and graphical output (400) of ray-tracing results.

### GOVERNMENT INTERESTS

The United States Government has rights in this invention under Contract No. DE-AC36-99G010337 between the United States Department of Energy and the National Renewable Energy Laboratory, a Division of the Midwest Research Institute.

### FIELD OF THE INVENTION

The present invention relates generally to analyzing optical systems. More particularly, the present invention relates to a method and system of generalized ray-tracing.

### BACKGROUND

Designers of optical devices often model the devices using a computer to optimize the design of the optical devices, before their manufacture and installation. An optical device typically has a number of optical elements such as mirrors, lenses, and/or receivers for capturing light for a specific purpose. For example, a telescope employs mirrors and lenses to capture, direct, and focus light to magnify a distant image. As another example, a solar concentrator may employ mirrors and lenses to focus light onto a receiver that converts the light energy into another form of energy. When modeling an optical device, a designer typically attempts to model the environment as closely as possible to the actual operating environment. A host of characteristics determine how the optical device will perform in the operating environment, such as the nature of the light source, the geometry of the optical elements, and optical errors in the elements.

Unfortunately, traditional optical modeling programs do not adequately provide for modeling a wide range of optical system characteristics that may arise in the actual environment. For example, typical computer modeling programs used in the field of photography, do not effectively model an extended light source, such as the sun, wherein photons of light are typically disbursed. These photographic modeling systems typically model only a point source of light wherein photons of light emanate from a single point with no dispersion. Some commercial modeling programs may allow for a collimated beam, but these programs do not model dispersion, which is characteristic of sunlight. Thus, current programs lack the ability to model an extended source, such as the sun, by modeling photon dispersion, including variable photon locations and directions.

Another limitation of traditional optical modeling programs is the inability to input measurement data characterizing an existing optical system and model the existing optical system. Measurement data is available from sources such as the Video Scanning Hartmann Optical Tester (VSHOT). The VSHOT is an optical analysis instrument that employs a laser to measure the slope error of solar concentrator mirrors. Experimental measurement data from existing optical systems has been made abundant as a result of advanced measuring instruments, such as the VSHOT. Unfortunately, traditional modeling programs have not been able to utilize the abundant experimental data to analyze errors in, and improve upon, existing optical systems.

Furthermore, traditional modeling programs are not able to simultaneously model a wide range of parameters such as optical element geometries, aperture types, optical element errors, the nature and geometry of the light source, multiple stages of optical elements, and generalized optical element surface descriptions. Traditional modeling systems may provide analytical surface descriptions defined with basic mathematical models, but do not allow for generalized surface descriptions such as axisymmetric analytical formulation and Zernike asymmetric formulation. Thus, current modeling programs do not provide for generalized optical modeling whereby a wide range of parameters common to optical systems may be modeled for optical system design and analysis. It is with respect to these and other considerations that the present invention has been developed.

### SUMMARY OF THE INVENTION

The present invention relates to a system and method of modeling optical systems using experimental input data and generalized model parameters. More particularly, embodiments of the present invention employ ray-tracing through one or more stages, each stage having one or more optical elements. Still more particularly, embodiments enable input of optical element error data associated with an existing optical system.

In one embodiment of the present invention, modeling an optical system includes defining a light source model having a frequency distribution relating a probability to a location within the light source, wherein the probability represents the likelihood that a ray will be selected at the location. The method further includes defining an optical device model and analyzing the interaction of a ray from the light source model with the optical device model. The modeled ray has one or more ray parameters, including a location and a direction. The location and direction may be defined in terms of a global, stage, or element coordinate system.

The modeling method further includes defining a first optical stage of the optical device model, and defining an optical element within the optical stage. Still further the modeling method includes generating a first modeled ray from a location on the light source model based on the frequency distribution, and determining a location on the optical element of the first stage at which the first modeled ray intersects the optical device model. The modeling method further includes determining an angle of reflection from the optical element at which the first modeled ray reflects from the optical element.

In another embodiment, the optical device includes an optical stage that has an optical element and defining the optical device model comprises defining optical stage model parameters characterizing the optical stage and defining optical element model parameters characterizing the optical element. Defining the optical stage model parameters includes defining a stage orientation and designating the optical stage as a virtual stage or an actual stage. In the embodiment, defining the optical stage may include inputting optical stage parameter data from a file containing optical stage parameter data. Defining the optical element includes defining an element geometry descriptor, defining a surface descriptor and defining a surface type descriptor.

Yet another embodiment may be viewed as an optics modeling system capable of modeling an optical system that has a light source, an optical element that has a front and back surface, and each of the surfaces may have optical properties. The model system includes a model creation module able to create an optical model of the optical system, a memory holding a data structure representing the optical properties of the front element and the optical properties of the back element, and a model execution module that communicates with the memory, reads the data structure, and traces a ray from the light source to the element based on the front and the back optical properties stored in the data structure.

The data structure includes an optical surface number representing the front or back surface of the optical element, two indices of refraction representing real and imaginary components of refraction associated with the front or back surface, an aperture stop field representing an aperture type of the optical element, a diffraction order field representing a level of diffraction of the front or back surface, a plurality of grating spacing polynomial coefficients, a reflectivity field, a transmissivity field, a root mean square slope error, a root mean square specularity error, and a distribution type representing a frequency distribution associated with the front or back surface. The distribution type of the optics modeling system may be Gaussian, pillbox, or another analytical distribution.

Yet another embodiment of the present invention relates to a graphical user interface (GUI) to facilitate entry of an optics system model. The GUI includes a light source shape definition window whereby a light source may be defined, a stage/element definition window whereby one or more stages of an optical device may be defined, a trace execution window whereby a ray-trace may be executed to gather ray trace data representing rays from the light source interacting with the one or more stages, and a plot window whereby the ray trace data may be plotted. The stage/element definition window includes an optical element data entry pane wherein one or more optical elements associated with the stages may be defined.

The invention may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its improvements can be obtained by reference to the accompanying drawings, which are briefly summarized below, and to the following detailed description of presently preferred embodiments of the invention, and to the appended claims.

### BRIEF DESCRIPTION OF THE DRAWINGS

FIG. 1 illustrates an exemplary solar concentrator that may be modeled using an optical modeling module in accordance with an embodiment of the present invention.

FIGS. 2A-2C are perspective views of optical elements illustrating examples of interdependence among elements that may be modeled by an optics-modeling module in accordance with aspects of an embodiment of the present invention.

FIG. 3 illustrates a suitable computing environment implementing an embodiment of an optics-modeling module.

FIG. 4 is a functional block diagram of an optics-modeling module of FIG. 3 in accordance with aspects of an embodiment of the present invention.

FIG. 5 is a flow chart illustrating an embodiment of an executive operation that may be employed by the optics-modeling module of FIG. 3.

FIG. 6 illustrates an exemplary user interface provided by the optics-modeling module.

FIG. 7 is a flow chart illustrating an embodiment of a defining operation employed by the optics-modeling module to define an optics model.

FIG. 8 is a flow chart illustrating an embodiment of the light source defining operation shown in FIG. 7.

FIG. 9 is a flow chart illustrating an embodiment of the optical geometry defining operation shown in FIG. 7.

FIG. 10 is a flow chart illustrating an embodiment of accepting operation shown in FIG. 9.

FIG. 11 illustrates a user interface that may be used in conjunction with the light source defining operation shown in FIG. 7.

FIG. 12 illustrates a user interface that may be used in conjunction with the optical model defining operation shown in FIG. 7.

FIG. 13 illustrates an embodiment of an element property data structure holding element properties.

FIG. 14 illustrates a ray reflecting off of an optical element at a randomly selected angle based on optical element properties in an embodiment of the element property data structure shown in FIG. 13.

FIG. 15 is a flow chart illustrating an embodiment of an executive trace operation that may be employed by the optics-modeling module of FIG. 3.

FIG. 16 is a flow chart illustrating an embodiment of the initializing operation shown in FIG. 15.

FIG. 17 is a flowchart of operations executed in the stage looping operation shown in FIG. 15.

FIGS. 18-21 are flowcharts of operations executed in the ray-tracing loop shown in FIG. 17.

FIG. 22 is a flowchart of operations executed in the element looping operation shown in FIG. 18.

FIG. 23 illustrates a user interface that may be used in conjunction with the executive trace operation shown in FIG. 15.

FIG. 24 is a flow chart illustrating a plotting operation that may be employed in an embodiment of the optics-modeling module shown in FIG. 3.

FIG. 25 illustrates a user interface that may be used in conjunction with the plotting operation shown in FIG. 24.

FIG. 26 illustrates another embodiment of a user interface that may be used in conjunction with the plotting operation shown in FIG. 24.

FIG. 27 is a flow chart illustrating an embodiment of the saving operation shown in FIG. 5.

### DETAILED DESCRIPTION

Embodiments of the optics modeling system discussed herein employ unique methods of representing all components in an optics system, including, but not limited to, photons, optical elements, light sources, and stages of optical elements of an optics device. Embodiments further employ unique methods of applying models to each of the components. Component models define component properties, including, but not limited to optical and geometrical properties. As is discussed in further detail, the models may be statistical, including models of both stochastic and deterministic processes that may be encountered in actual optics systems. Further, embodiments allow a user of a computer system to define, execute, and view results of an optics model using an easy-to-use interface.

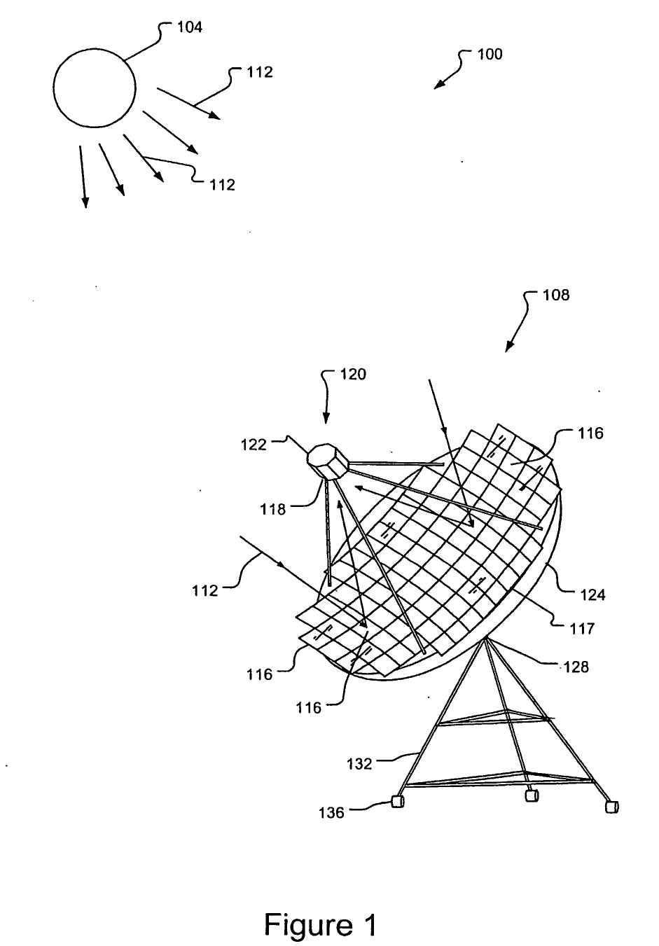

An exemplary optics system 100 is illustrated in FIG. 1 that may be modeled using an optics-modeling module in accordance with aspects of an embodiment of the present invention. The optics system 100 includes a variety of components and environmental factors that may be modeled, including a receiver, a light source, and stages of optical elements that may be modeled by the optics-modeling module. The optics system 100 includes a light source, such as the sun 104, which generates sunlight in the form of optical rays or photons 112, which emanate from the sun 104 at varying locations and at varying angles. The photons 112 move in a direction generally toward an optics device, such as a solar concentrator 108, which receives one or more of the photons 112.

The solar concentrator 108 is a generally parabolically shaped dish 124 holding one or more optical elements, such as reflectors 116, which reflect photons 112 toward a receiver device 120. The reflectors 116 are positioned in a matrix 117 at various positions and orientations on the dish 124 to reflect photons 112 at various associated directions. The receiver 120 has a lens or mirror system 118, for focusing or for further concentrating the photons 112. The photons 112 are focused onto a surface of another optical element, such as an energy converter 122, in the receiver 120 where the photons 112 are converted from light energy into another form of energy, such as electrical energy. The solar concentrator 108 is mounted 128 on a support structure 132 and preferably directed at the sun 104. The support structure 132 may include rotatable elements, such as wheels 136, whereby the support structure 132 and dish 124 may be moved. In addition, the dish 124 may be rotatably mounted 128 with a tracking device so that the dish 124 follows the sun 104 as the sun 104 moves.

To assist the reader in understanding the solar concentrator 108 and how it may be modeled, it is assumed that the energy converter 122 of the receiver 120 has a number of Photo Voltaic (“PV”) cells for energy conversion. It is to be understood, however, that other types of energy converters that are known in the art may be modeled by embodiments of the present invention. The photons 112 from the sun 104 comprise electromagnetic radiation in a whole spectrum of wavelengths, ranging from higher energy ultraviolet with wavelengths less than 390 nm to lower energy near-infrared with wavelengths as long as 3000 nm. Between these ultraviolet and infrared wavelengths or electromagnetic radiation energy levels are the visible light spectrum, comprising violet, blue, green, yellow, orange, and red wavelengths or energy bands. The PV cells of the energy converter 122 convert the photons 112 directly into electricity.

Preferably, all the photons 112 reflected by the reflectors 116 are received by the receiver 120. In operation, however, for a number of reasons some of the photons 112 may not be received by the receiver 120, and are therefore not converted to electrical energy. Primary determinants of whether photons 112 are reflected toward and received by the receiver 120 are the location, orientation, and surface properties of the reflectors 116. For example, one or more of the reflectors 116 may have been installed incorrectly (e.g., at the wrong position or wrong angle), such that when photons impact the misinstalled reflectors 116, the photons are reflected away from the receiver 120. As another example, the reflectors 116 may have been installed correctly, but over time have become mispositioned due to vibration.

As a further example, optical errors, such as aberrations, may exist in the reflectors 116. Photons 112 incident upon a reflector having optical errors may be absorbed by the reflectors 116 or pass through the reflectors 116. For all of these reasons, as well as others, the photons 112 that are incident upon the reflectors 116 often do not reflect toward the lens 118 of the receiver 120. Misdirected photons 112 may miss the receiver 120 entirely, or may miss the lens 118 and deflect off a portion of the receiver 120.

Thus, in operation, photons 112 are typically not received at one point on the receiver; rather, they are distributed about the surface of the receiver. The distribution of photons is related to the amount of solar energy received at any particular point on the receiver. The distribution of photons across or through a surface is often referred to as a flux map and characterizes the optical efficiency of the optical system 100.

An embodiment of the present invention is operable to model the optics system 100. A computer model is created that represents the components and environment of the optics system 100. The model emulates the path of the photons 112 from the sun 104 to the receiver 120 and provides data about the photons 112 at various stages in the path. In general, a stage is any surface along the path of a photon 112. For example, in FIG. 1, one stage is the matrix 117 of reflectors 116. As another example, the lens 118 is a stage. Additionally, embodiments enable the user to define ‘virtual’ stages that represent virtual surfaces (discussed below) in the optical system 100 that do not include any physical optical elements. Embodiments of the present invention may allow a user to predict how photons 112 will interact with stages and elements of an optic device such as the solar concentrator 108.

It is to be understood that the optics system 100 is only one example of an optics system that may be modeled using embodiments of the present invention, and that embodiments described herein may be used to model optical systems having optics devices other than a solar concentrator 108, and light sources other than the sun 104. By way of example, and not limitation, other optics devices that may be modeled using embodiments described herein are telescopes, cameras, microscopes, and optical energy systems, such as, but not limited to, power towers, trough systems, and solar furnaces, among others. In general, any optics system that includes an optics element(s) and a light source may be modeled using an embodiment of the present invention. The significant utility of an embodiment will be realized in its ability to model optics systems that further include multiple optical elements and one or more stages of optical elements.

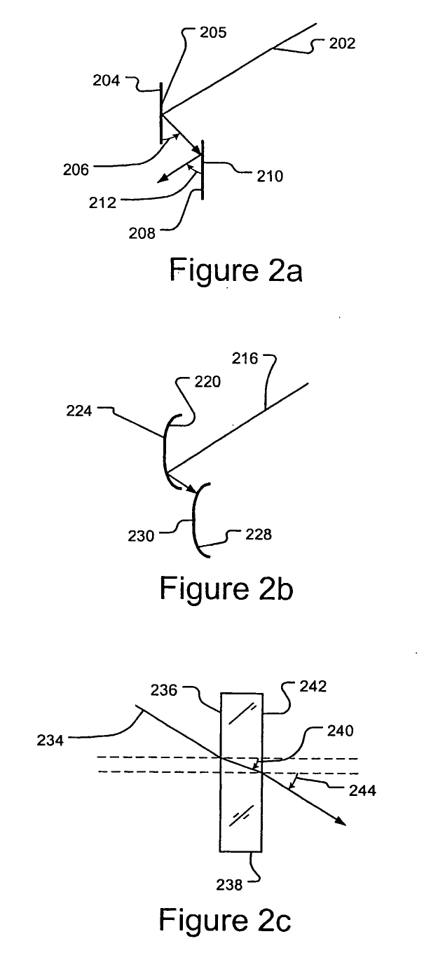

FIGS. 2A-2C illustrate rays interacting with multiple optical elements in stages of an optical system. The exemplary scenarios illustrated and described with respect to FIGS. 2A-2C are intended to assist the reader in understanding all types of scenarios that may be modeled in an embodiment. Many other scenarios may be modeled in an embodiment, as will be readily apparent to one skilled in the art after reading the entire specification.

A ray is shown interacting with two optical elements in FIG. 2A. The ray has a path 202 that intersects with a first element 204. The path 202 intersects at a point on a front side of the first element 204 and reflects off of the element 204 at an angle of reflection 206. The reflective ray then intersects a location on the backside 208 of a second element 210. The ray reflects off the backside 208 of the second element at an angle 212. As illustrated in FIG. 2A, the first element 204 and second element 210 are not oriented in a planar fashion with respect to each other but rather the second element 210 is in front of the first element 204 whereby the ray path 202 intersects both the first element 204 and the second element 210. Multiple reflections as are illustrated in FIG. 2A may be modeled in an optical modeling system described herein.

FIG. 2B illustrates a ray following a path 216 and intersecting a front side 220 of a third optical element 224 and reflecting into a fourth element 228. The ray path 216 intersects the backside 230 of the fourth optical element 228 but stops there. The path 216 is intended to illustrate a situation in which a ray reflects off one element into another element and is absorbed upon impact with the fourth element 228. Ray absorption scenarios as depicted in FIG. 2B are readily modeled by a system implementing the methods described herein.

A ray path 234 is depicted in FIG. 2C as impacting a front side 236 of a fifth optical element 238. The ray is refracted upon impact with the front side 236 of the element 238 at a refraction angle 240. The ray transmits through the optical element 238 and intersects a backside 242 of the optical element 238. Upon impact with the backside 242 of the optical element 238, the ray is again refracted at an angle of refraction 244. Refraction scenarios as depicted in FIG. 2C are readily modeled in an embodiment of the optical modeling module of the present invention.

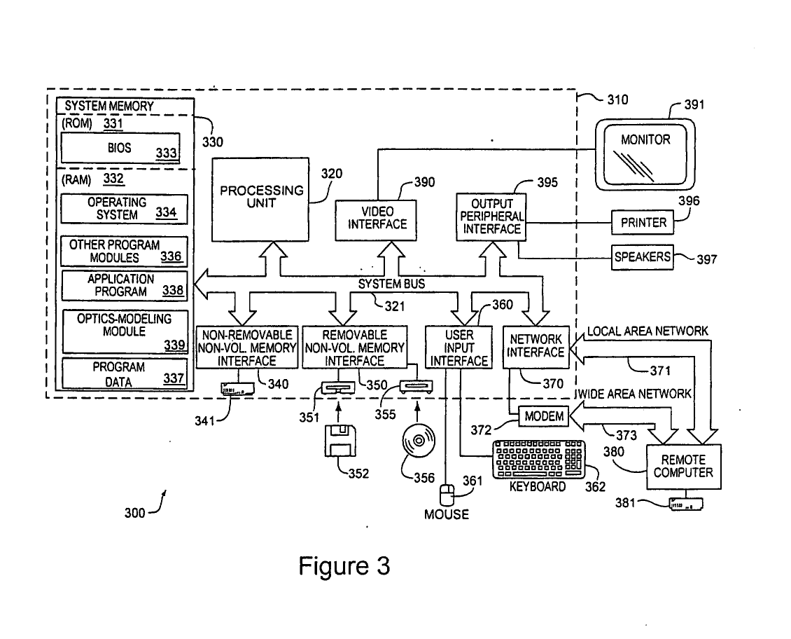

FIG. 3 illustrates an example of a suitable computing system environment 300 on which the invention may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the invention includes a general purpose-computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented by any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 338, other program modules 336, program data 337, and a optics-modeling module 339.

As is discussed throughout in detail, the optics-modeling module 339 is an executable application program that provides a user of the computer system 310 the ability to model an optics system (such as the optics system 100 in FIG. 1). In one embodiment, the optics-modeling module 339 provides a graphical user interface allowing the user to create a model in a generalized fashion, execute the model, and view results of the execution.

The computer 310 may also include other removable/non-removable, volatile/nonvolatile computer storage media. By way of example only, FIG. 3 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through an non-removable memory interface such as interface 340, and magnetic disk drive 351 and optical disk drive 355 are typically connected to the system bus 321 by a removable memory interface, such as interface 350. The drives and their associated computer storage media discussed above and illustrated in FIG. 3, provide storage of computer readable instructions, data structures, program modules and other data for the computer 310.

A user may enter commands and information into the computer 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor 391, computers may also include other peripheral output devices such as speakers 397 and printer 396, which may be connected through an output peripheral interface 395.

The pointer device 361 may be manipulated by the user to move a pointer that is visually displayed on the monitor 391. The pointer is any visual display element that responds to manipulations of the pointer device 361 by the user. For example, in the case of the mouse 361, the pointer may be a graphical arrow that moves on the monitor when the mouse 361 is moved. Visual display elements, such as buttons, displayed on the monitor 391 may be selected by the user using the pointer. The pointer may also be used to select text, activate a scroll bar, check a checkbox, and/or move a cursor. A cursor may be displayed on the monitor 391 at positions where data may be entered by the user using the keyboard 362.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device 381. It will be appreciated that the network connections shown are exemplary and other means of establishing a communications link between the computers may be used.

Although many other internal components of the computer 310 are not shown, those of ordinary skill in the art will appreciate that such components and the interconnection are well known. Accordingly, additional details concerning the internal construction of the computer 310 need not be disclosed in connection with the present invention.

Those skilled in the art will understand that program modules such as the operating system 334, application programs 338 and 339, and data 337 are provided to the computer 310 via one of its memory storage devices, which may include ROM 331, RAM 332, hard disk drive 341, magnetic disk drive 351 or optical disk drive 355. Preferably, the hard disk drive 341 is used to store data 337 and programs, including the operating system 334 and application programs 338 and 339.

When the computer 310 is turned on or reset, the BIOS 333, which is stored in the ROM 331 instructs the processing unit 320 to load the operating system from the hard disk drive 341 into the RAM 332. Once the operating system is loaded in RAM 332, the processing unit 320 executes the operating system code and causes the visual elements associated with the user interface of the operating system 334 to be displayed on the monitor 391. When an application program, such as application 338 is opened by a user, the program code and relevant data are read from the hard disk drive 341 and stored in RAM 392.

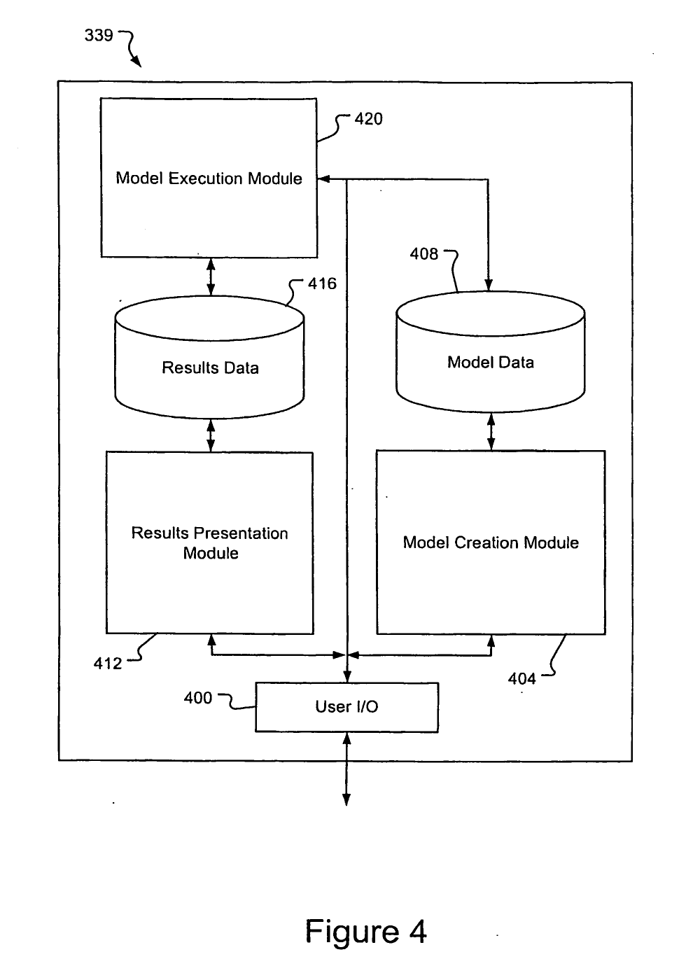

FIG. 4 is a module diagram illustrating primary functional components that may be employed by the optics-modeling module 339 of FIG. 3. One embodiment of the optics-modeling module 339 is implemented with executable software, executable by the processing unit 320. The optics-modeling module 339 has a number of modules that allow a user of a computer system, such as the computer system 310 in FIG. 3, to create an optics model, execute the model to emulate an optics system (such as optics system 100 of FIG. 1), and view modeling results in a number of formats. An input/output (I/O) module 400 serves as an interface to the optics-modeling module 339. The I/O module 400 receives data from and transmits data to other modules in the computer system 300 to allow a computer user to interact with the optics-modeling module 339.

For example, the I/O module 400 may cause graphical user interface (GUI) information to be transmitted via the system bus 321 to the video interface 390, which will responsively present a GUI on the monitor 391. As another example, the user may select an option presented on the monitor 391 via the mouse 361 or the keyboard 362. The user's selection is received by the user input interface 360, and transmitted via the system bus 321 to the processing unit 320, whereby the user's selection will be received by the I/O module 400. The I/O module 400 will communicate with other modules in the optics-modeling module 339 to process the user's selection. Exemplary embodiments of the user interface are described in detail below.

The user I/O module 400 interfaces with a model creation module 404. The model creation module 404 provides functions that enable a user to create or edit an optics model. The optics model that is created or edited is stored as a set of model data 408 that characterizes the optics system to be modeled. The type and format of data in the model data 408 is described in further detail below. A model execution module 420 accesses the model data 408 to emulate the optics system being modeled. In one embodiment, the model execution module 420 receives commands from the I/O module 400 to, for example, “run” and/or “stop” model execution. In response to receiving a run command, the model execution module 420 emulates the optics system represented by the model data 408. The model execution module 420 stops emulation in response to receiving a stop command from the user I/O module 400.

While the model execution module 420 is emulating the optics system using the model data 408, the model execution module 420 stores and retrieves emulation results to and from a results data database 416. After the model execution module 420 stops emulation, a results presentation module 412 presents the results data 416 to the user via the I/O module 400. The results presentation module 412 formats the results data 416, and sends the formatted results data to the user I/O module 400, which outputs the formatted emulation results on the monitor 391, to the printer 396, the remote computer 380, or any other output device. As is discussed in more detail, the emulation results are presented to the user in a number of selectable, manipulatable, easy-to-view formats.

With reference to the model data 408, the model data 408 has a host of data describing an optics system to be modeled. The model data 408 includes, for example, and without limitation, light source data, one or more sets of stage data, receiver data, and light ray data, representing an optical light source (such as the sun 104 in FIG. 1), one or more stages in the optics system (such as the optics elements 116 in FIG. 1), a receiver (such as the receiver 120 in FIG. 1), and photons (such as photons 112 in FIG. 1) in the optics system, respectively. Each of the sets of stage data in the model data 408 may have one or more sets of element data representing optical elements (such as the reflectors 116, lens 118, or energy converter 122 of FIG. 1) in each of the stages of the optics system 100. The model execution module 420 accesses the model data 408 to emulate light rays or photons as they may travel through the modeled optics system.

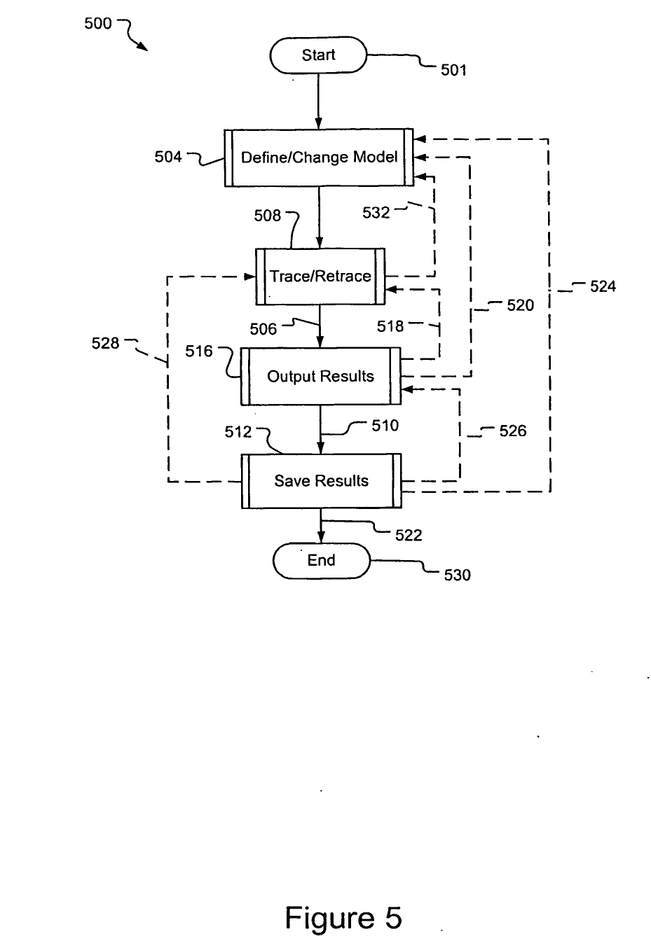

The functional block diagram of the optics-modeling module 339 shown in FIG. 4 may be implemented as software, hardware (e.g., an ASIC), firmware or any combination thereof. The functions performed by the modules illustrated in FIG. 4 are described below in a series of flowcharts, which will enable those skilled in the art to readily implement an embodiment of the optics-modeling module 339. An executive operation 500 that may be employed by the optics-modeling module 339 is illustrated in FIG. 5. The executive operation 500 includes a number of steps or operations to input and change an optics model, execute the model, and output and save model execution results. At each step of the executive operation 500, the next step in the operation 500 may be entered via a primary path, or a previous step may be re-entered through an alternative path. A user of the optics-modeling module 339 may choose at each step in the operation 500 whether to take the primary path or an alternative path. The primary paths (shown with solid lines) of the executive operation 500 are discussed first, followed by the alternative paths (shown with dotted lines).

Initially, in a defining operation 504 an optics model is defined and/or changed. The defining operation 504 stores a newly created or edited optics model in the model data 408 (shown in FIG. 4). The defining operation 504 may be carried out by the model creation module 404 and the user I/O module 400 (shown in FIG. 4) in response to user input. An optics model includes data that defines a light source and elements at stages in the system being modeled. The user input is discussed in more detail below with reference to graphical user interfaces (GUIs) that are provided by the optics-modeling module 339.

After an optics model has been defined in the defining operation 504, a tracing operation 508 traces (or retraces) one or more light rays through the optics model. The tracing operation 508 emulates rays as they emanate from the light source and progress through stages of the optics model. Tracing a ray involves calculating a path for the ray based on numerous parameters, including, but not limited to, ray direction, light source type and location, and element type, orientation, location, and errors (if any). The tracing operation 508 stores ray-trace results data in memory such as the results data 416, which may be later output and/or permanently stored in a file. The tracing operation 508 may be carried out by the model execution module 420 (shown in FIG. 4).

After the tracing operation 508, processing continues via a primary path 506 to an outputting operation 516, which outputs the previously stored results. The outputting operation 516 may be carried out by the results presentation module 412 (FIG. 4) and the user I/O module 400. The outputting operation 516 reads the results data 416 and presents it to the user in a selected format (e.g., scatter plots, flux distribution plots, and optical performance curves) using a number of output devices (e.g., display monitor or printer). The outputting operation 516 responds to user input from the user I/O module 400 when, for example, the user selects an output format. The plot selection process and possible plot formats are discussed below in more detail with reference to GUIs provided to the user by the optics-modeling module 339.

After the outputting operation 516 has presented the ray-tracing results, a saving operation 512 is entered via a primary path 510. The saving operation 512 saves the results of the tracing operation 508 in a substantially permanent form, such as a file. The saving operation 512 retrieves data from the results data 416 and saves it in memory as designated by the user. The results data may be stored on portable memory media, such a floppy disk, or fixed memory media, such as network server memory media. In one embodiment, the results data is stored in an ASCII text file. Those skilled in the art will readily recognize other data formats for storing the results data. By way of example, and not limitation, the saving operation 512 may convert the results data to a known format, such as a spreadsheet format, and/or compress the results data. The saving operation 512 may be carried out by the model execution module 420 and the user I/O module 400. After the ray-tracing results are stored in the saving operation 512, a primary path 522 is taken to end the executive operation 500.

The embodiment of the executive operation 500 in FIG. 5 includes a number of alternative paths for illustrative purposes. The alternative paths shown in FIG. 5 are not meant to be an exhaustive listing of all available alternative paths, but are intended to suggest to the reader alternative embodiments that are within the scope of the present invention. To illustrate, during or after the tracing operation 508, an alternative path 532 may be taken back to the defining operation 504. The alternative path 532 may be taken, for example, during or after the tracing operation 508, if the user stops model execution and wants to change the optics model that was previously defined and stored. The defining operation 504 and the tracing operation 508 may be reentered from the outputting operation 516 via paths 520 and 518, respectively. The defining operation 504, the tracing operation 508, and the outputting operation 516 may be re-entered from the saving operation 512 via alternative paths 524, 528, and 526, respectively. The alternative paths exist in the executive operation 500 primarily to provide the user of the optics-modeling module 339 with control of the modeling process and ease-of-use.

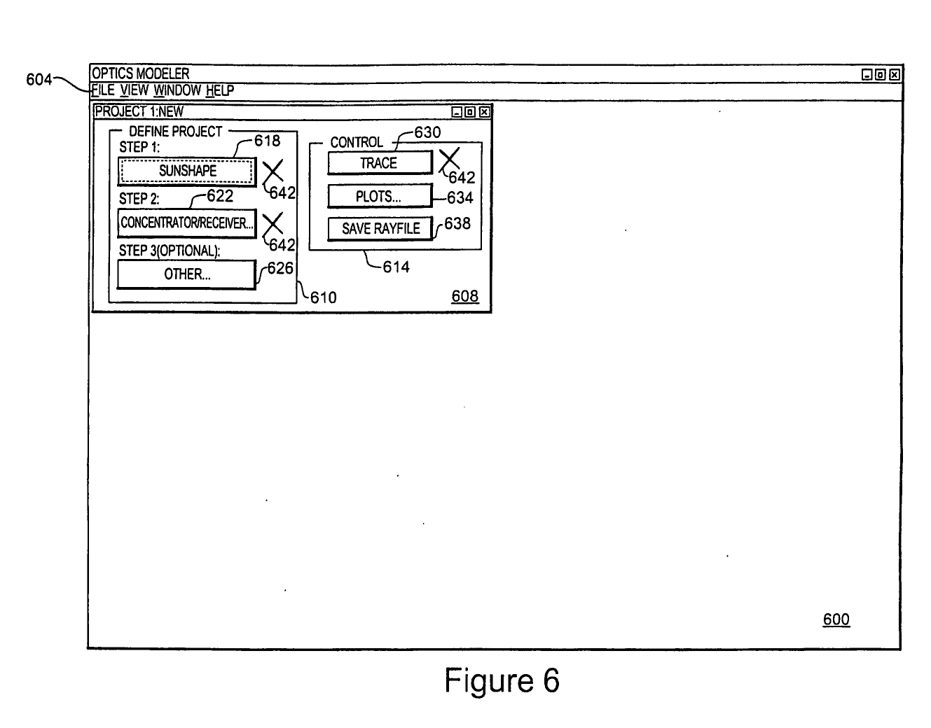

FIG. 6 illustrates a user interface 600 that may be provided by the optics-modeling module 339 to facilitate user definition and execution of the optics model as well as viewing and manipulation of results data. The user interface 600 enables a user to define a light source and other optics system elements to create a model of an optics system. The user interface 600 also enables the user to control the execution of the optics-modeling module 339, by executing a trace, plotting output results, and/or saving ray-trace results. The user interface 600 may be implemented in conjunction with the executive operation 500 illustrated in FIG. 5.

The user interface 600 includes a menu 604 often referred to as a “drop-down” menu, which provides a list of options when the user selects one of the menu headings (i.e., “FILE”, “VIEW”, “WINDOW”, and “HELP”). The menu 604 enables the user to perform file operations, choose viewing preferences, adjust windows of the user interface 600, and obtain help regarding how to use the optics-modeling module 339. The menu 604 items offer the user options that are generally known in the art including, but not limited to, an option to exit the optics-modeling module 339. A project window 608 provides options that are specific to optics modeling. In one embodiment, the project window 608 includes a define project frame 610 and a control frame 614.

The define project frame 610 includes a number of selectable visual display elements, such as a light source definition button 618, a stage/element button 622, and an “other” button 626. When the user selects the light source definition button 618, such as, by using the pointer device 361 (FIG. 3), a light source defining operation is executed. The light source defining operation is discussed in more detail below.

When the user selects the stage/element button 622, a stage/element defining operation is executed, whereby the user may define the optical stages and elements in an optical system. The “other” button 626 is provided for additional functionality. The “other” button 626 allows the user to define miscellaneous parameters suitable to the particular implementation such as direct normal insolation (DNI). The control frame 614 includes visual display elements for controlling the execution of a ray-trace after the optics model has been defined with the buttons in the define project frame 610. Visual display elements in the control frame include, but not limited to, a trace button 630, a plot button 634, and a save button 638.

A “completed” visual display element 642 is provided to indicate to the user that the associated step has been completed. The step completed visual display element 642 will appear when the associated step has been completed. Thus, for example, after the user defines the light source using the light source definition button 618, the completed visual display element 642 will appear beside the light source definition button 618. Similarly, after the user defines the stages and elements using the stages/element button 622, the completed visual display element 642 will appear beside the stages/element button 622. After the light source is defined and the stages and elements are defined in the optics model, the user may execute a ray-trace using the trace button 630. When the user selects the trace button 630, a ray-trace operation may be performed. After the ray-trace has been executed, another “completed” visual display element 642 is displayed next to the trace button 630.

After the ray-trace has been executed, the plot button 634 and the save button 638 may be used to view, analyze, and/or save the results from the ray-trace. As is discussed in more detail below, the plot button 634 activates a plotting operation wherein the user may select a plot type based on selected stages, elements, and rays stored during the ray-trace operation.

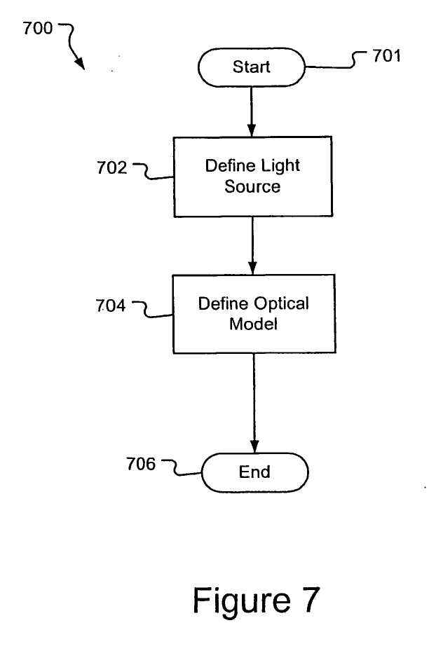

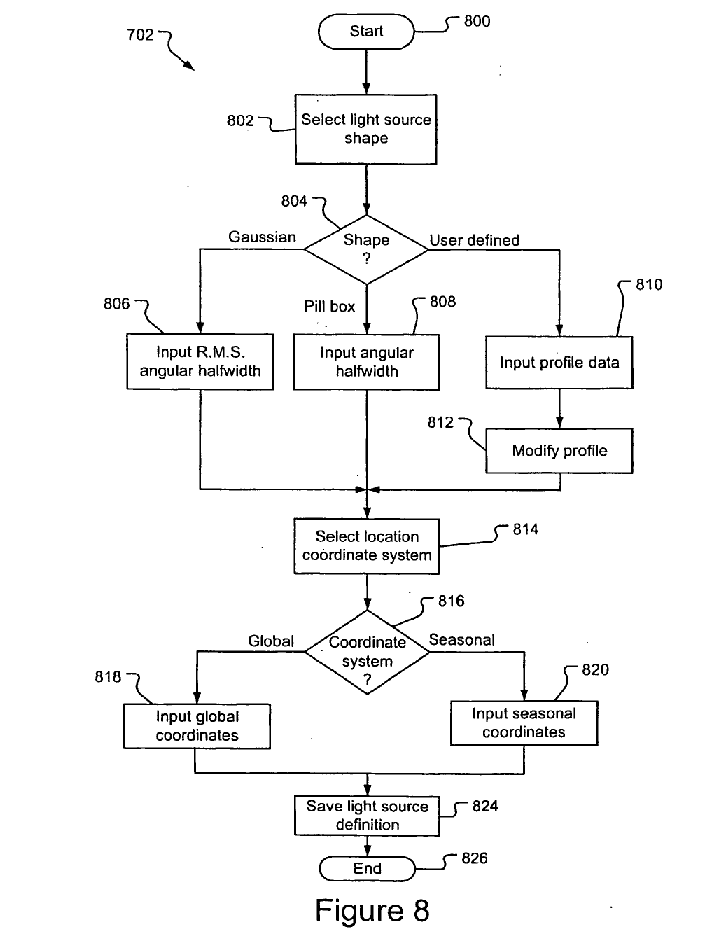

As noted, in response to the user selecting the model definition buttons (e.g., the light source definition button 618 or the stage/elements button 622) a model defining operation may be executed to facilitate defining an optics model. FIG. 7 illustrates operations that may be carried out by the model defining operation 700 in accordance with an embodiment of the present invention. A light source defining operation 702 prompts the user to enter data that defines the light source to be modeled. One embodiment of the light source defining operation 702 is presented in FIG. 8 and discussed in detail below. In general, the light source defining operation 702 enables the user to enter attributes of the light source being modeled, and stores those attributes to be used during the ray-trace operation. Exemplary options that are available to the user for defining the light source are discussed in more detail below with reference to a graphical user interface (GUI), which is one mechanism by which the user may define the light source.

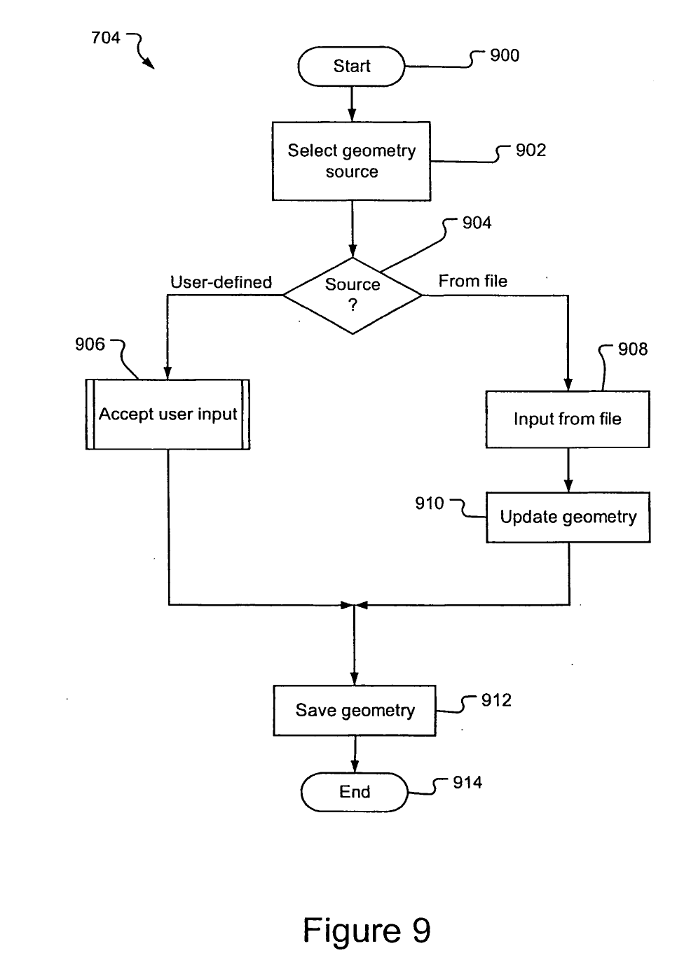

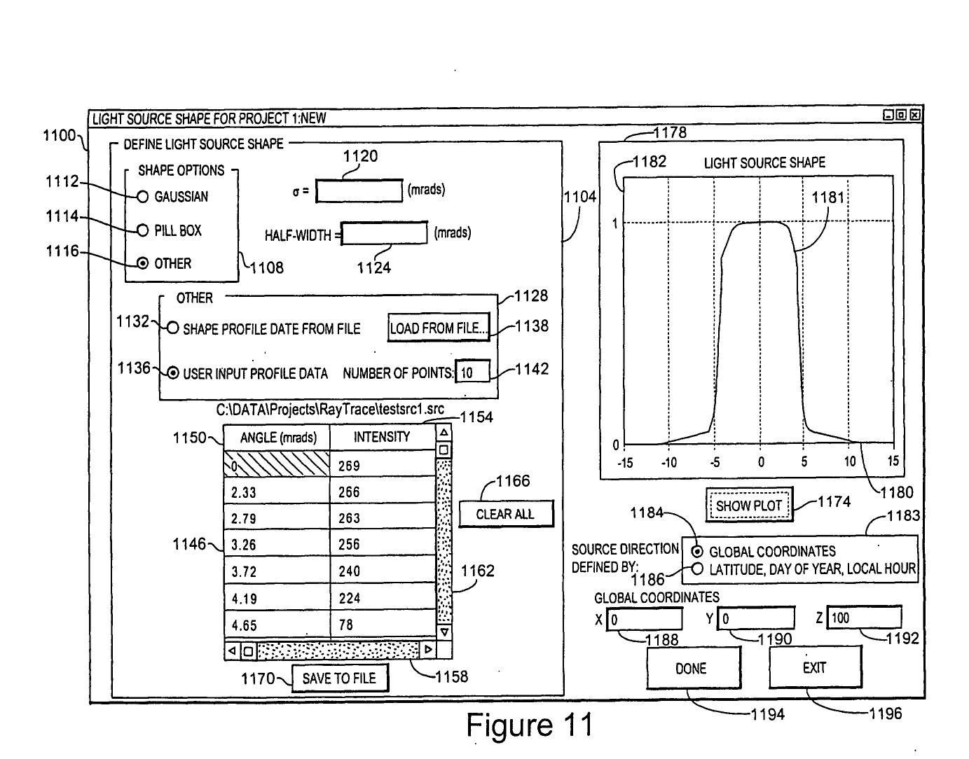

An optical model defining operation 704 allows the user to define various model parameters, including, but not limited to, optical model geometry and properties of the stages and elements in the optics system to be modeled. The optical model defining operation 704 enables the user to define the optical geometry and properties associated with the optics device in the optics system being modeled. An embodiment of the optical model defining operation 704 is illustrated in FIG. 9 and is discussed in detail below. Exemplary optical geometry and property attributes that may be selected by the user are shown and discussed with reference to FIG. 11, which depicts a graphical user interface (GUI) that enables the user to enter stages, optical elements, and their geometries and properties.

As noted, an embodiment of the light source defining operation 702 is illustrated in FIG. 8. After a start operation 800, a selecting operation 802 selects a light source shape in response to user input. The light source shape that is selected in the selection operation 802 characterizes or represents the light source that is to be modeled, and defines how and where light rays emanate from the light source. The light source shape may be a frequency distribution such as a Gaussian or Pill Box distribution, or a point source shape, or any user defined light source shape. A determining operation 804 tests the light source shape that was selected in the selecting operation 802.

If the light source shape is Gaussian, a “Gaussian” path is taken to an inputting operation 806. If the light source shape is a Pill Box, a “Pill Box” path is taken to an inputting operation 808. If the light source shape is user defined, a “user defined” path is taken to an inputting operation 810. Each of the paths, “Gaussian”, “Pill Box”, and “user defined”, are followed to operations for entering parameters or data associated with the selected light source shape (i.e., Gaussian, Pill Box or user defined). In the inputting operation 806, a root mean square (RMS) and an angular half-width parameter are input to define a Gaussian light source shape. In the inputting operation 808, an angular half-width is input to define a Pill Box light source shape. In the inputting operation 810 profile data is input associated with a user defined light source shape.

After the inputting operation 810, a modifying operation 812 may be performed to modify the profile data that was input in the inputting operation 810. In the modifying operation 812, the user may modify the profile data and save the profile in a file for later use.

After the light source shape parametric data is entered and/or modified in each of the inputting or modifying operations 806, 808, 810 and 812, a selecting operation selects a location coordinate system. The selecting operation 814 chooses, determines, and/or calculates a coordinate system to be used as a global reference coordinate system for the light source. In one embodiment, the user may define the global coordinate reference system using either global coordinates or seasonal coordinates. This embodiment is particularly useful for modeling the sun, because the position of the sun is determined by the season.

In the embodiment wherein the user may select between global coordinates and seasonal coordinates, a determining operation 816 determines which types of location coordinates were selected in the selecting operation 814. If the selected coordinates are global coordinates, a “global” path is taken from the determining operation 816. If the selected coordinates are seasonal coordinates, a “seasonal” path is taken from the determining operation 816. The “global” path enters an inputting operation 818 wherein global coordinate data are input. The “seasonal” path enters an inputting operation 820 wherein seasonal coordinate data are input. Inputting global and seasonal coordinate data is described in detail below. If seasonal coordinates are entered, they are preferably converted to global coordinates using any appropriate conversion technique. Converting seasonal coordinates to global coordinates typically involves using a mathematical sun position as a function of time to map seasonal coordinates to global coordinates. After both the inputting operation 818 and the inputting operation 820, a saving operation 824 saves the light source shape data and the coordinate reference system data in memory. The light source shape data and the coordinate reference system data will be used during the ray-trace operation discussed below. After the saving operation 824, the light source defining operation 702 ends at ending operation 826.

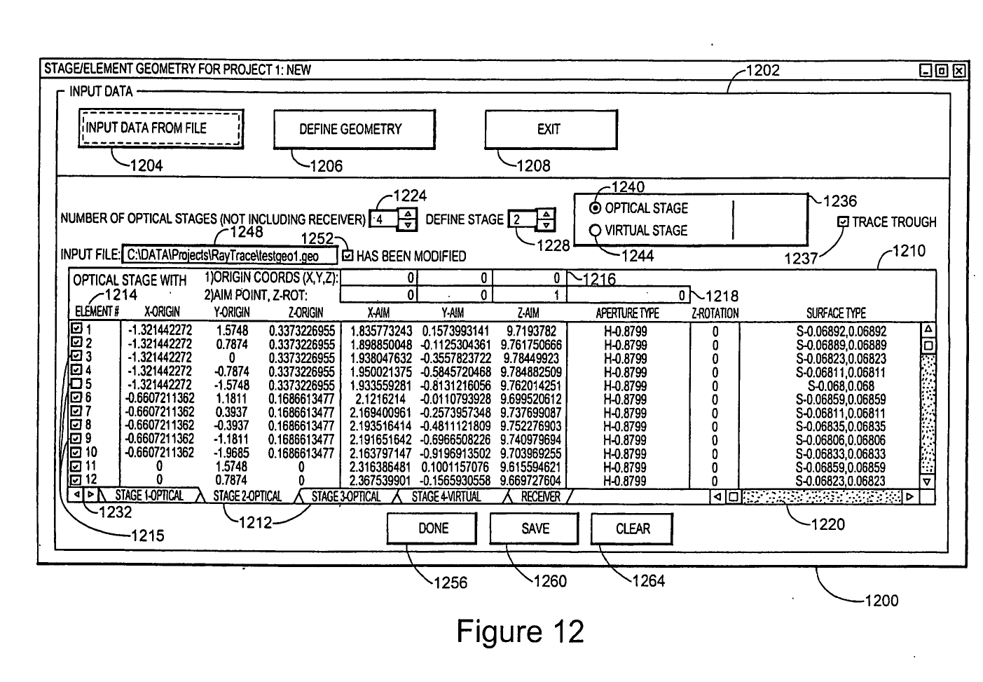

As noted above, FIG. 9 is a flowchart illustrating operations that may be employed in an embodiment of the optical model defining operation 704 shown in FIG. 7. The optical model defining operation 704 defines model parameters that are not defined in the light source defining operation 702, such as geometries, positions, orientations, and optical properties. After a starting operation 900, a selecting operation 902 selects a source for stage and element geometry in response to user input. The source refers to a resource from which the optical geometry and property may be obtained. In one embodiment, the user may select geometry and property source data contained in a file or choose to manually enter user-defined geometry and property data. In another embodiment, the geometry and property data may be derived from a combination of data from a file and data entered by the user. Exemplary types of geometry and property data, and exemplary mechanisms for entering the data are discussed in detail with reference to an embodiment of a user interface shown in FIG. 12.

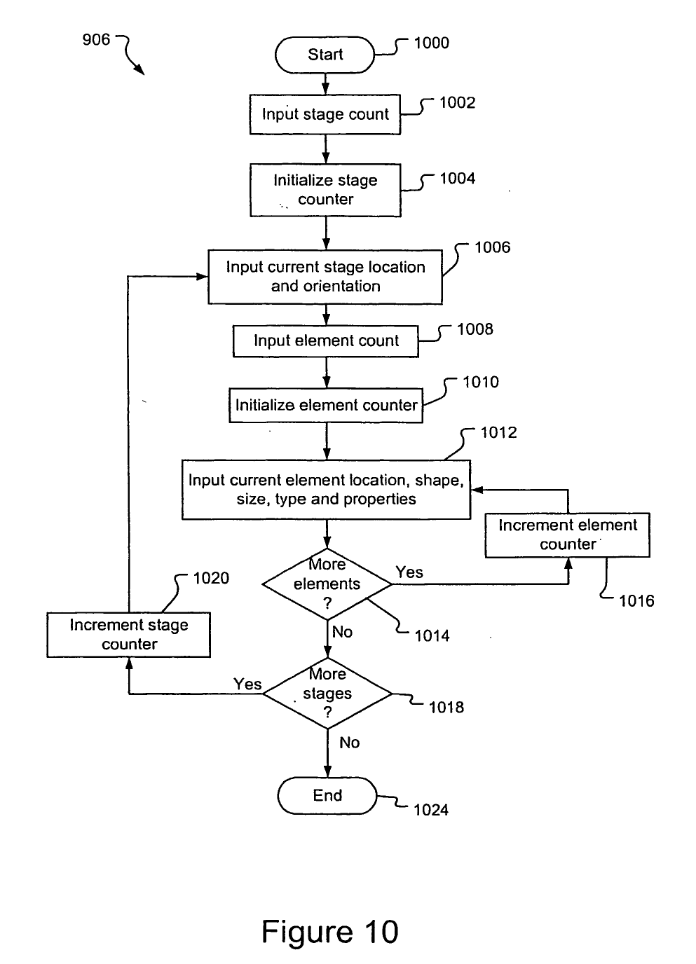

A determining operation 904 determines which source was selected in the selecting operation 902. If a user-defined source was selected in the selecting operation 902, a “user-defined” path is taken from the determining operation 904. If a file was selected as the source for geometry and property data, a “from file” path is taken from the determining operation 904. The “user-defined” path enters an accepting operation 906, wherein user input is accepted that defines the stage and element geometry and properties. An embodiment of the accepting operation 906 is illustrated in FIG. 10 and discussed in more detail below.

The “from file” path enters an inputting operation 908 wherein the stage and element geometry and property information is input from a file identified by the user. The file may be in any format recognizable by the optics-modeling module 439 and is implementation dependent. In one embodiment the file is a text file. In another embodiment, the file may be in a proprietary format. In yet another embodiment, the file is compressed in memory. If it is compressed, it will need to be decompressed before being input. After the inputting operation 908, an updating operation 910 may update the stage and element geometry and properties. In the updating operation 910, the user may modify the data read from the file, and the changes may be saved back to the file or to another file.

After both the accepting operation 906 and the updating operation 910, a saving operation 912 saves the geometry information. The saving operation 912 saves the geometry information in memory, such as RAM, so that it can be used during a ray-tracing operation discussed below. After the saving operation 912 has saved the geometry and property information, the optical model defining operation 704 ends at ending operation 914. The types and sorts of stage and element optical geometries that may be entered during the optical model defining operation 704 are described below in more detail.

As noted above, FIG. 10 is a flowchart illustrating operations that may be executed in an embodiment of the accepting operation 906 shown in FIG. 9. After a starting operation 1000, an inputting operation 1002 responds to user input by inputting a stage count designating a number of stages in the optical model. In the inputting operation 1002, the user enters the number of optical stages in the model. As discussed in more detail below, the optical stages may represent physical stages in an optical system or virtual stages.

An initializing operation 1004 initializes a stage counter variable, which will designate a “current” stage used during the stage definition operations discussed below. An inputting operation 1006 responds to user input by inputting a current stage location and orientation. As mentioned, the current stage of the inputting operation 1006 is designated by the stage counter variable initialized in the initializing operation 1004.

The current stage location and orientation that are input in the inputting operation 1006 are defined with reference to the global reference coordinate system that was selected in the selecting operation 814 (FIG. 8). As is discussed in more detail with regard to FIG. 12, one embodiment defines the current stage location and orientation with (x, y, z) coordinates, a z-axis aim point, and a z-rotation value. After the current stage location and orientation are input in the inputting operation 1006, another inputting operation 1008 inputs an element count representing the number of elements in the current stage. In the inputting operation 1008, the user enters the number of elements to be modeled in the current stage.

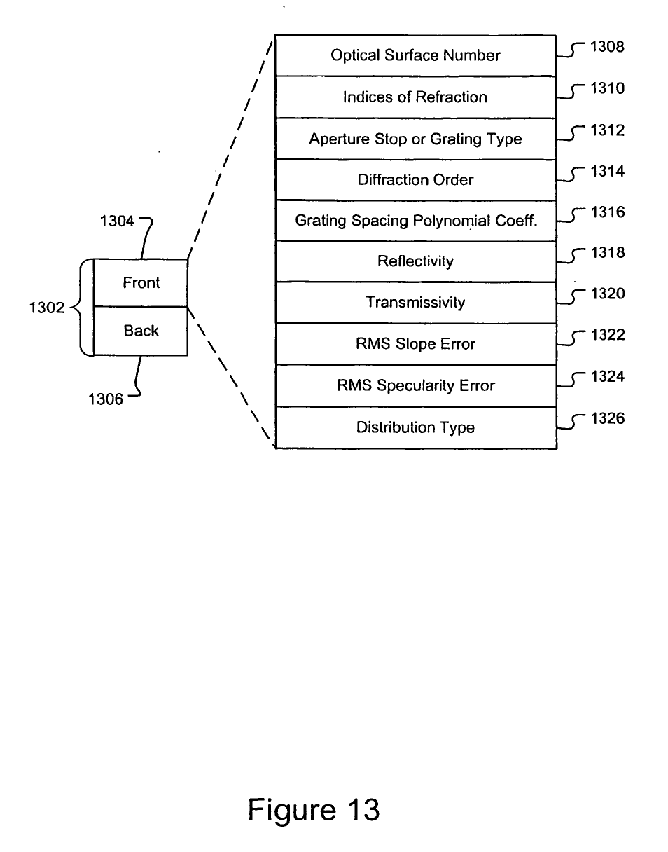

An initializing operation 1010 initializes an element counter that is used to index through the elements of the current stage. The element counter is used to designate to a “current” element. An inputting operation 1012 responds to user input by inputting current element data including, but not limited to, element location, shape, size, type, and properties. The current element is designated by the element counter that is initialized in the initializing operation 1010. The element information input in the inputting operation 1012 is discussed in more detail with reference to FIG. 12 and FIG. 13 below. After the inputting operation 1012, a determining operation 1014 determines if any more elements are in the current stage to be defined.

If more elements are to be defined, a “yes” path is taken from the determining operation 1014 to an incrementing operation 1016. The incrementing operation 1016 increments the element counter variable to the next element in the current stage. After the incrementing operation 1016, the inputting operation 1012 is re-entered to input definition information for the current element. If no more elements remain to be defined (i.e., the element counter designates the last element in the current stage) in the determining operation 1014, a “no” path is taken from the determining operation 1014 to another determining operation 1018.

The determining operation 1018 determines whether more stages remain to be defined in the optical model. If more stages are to be defined, the determining operation 1018 takes a “yes” path to an incrementing operation 1020. The incrementing operation 1020 increments the stage counter variable to reference the next stage in the optical model. After the incrementing operation 1020, the inputting operation 1006 is re-entered to input information for the current stage in the optical model. If, on the other hand, no more stages remain to be defined, the determining operation 1018 takes a “no” path to an end operation 1024 that ends the accepting operation 906.

A user interface is illustrated in FIG. 11 that may be used to facilitate light source definition in an embodiment of the optics-modeling module 339. The user interface may be used in conjunction with the “light source” defining operation 702 shown in FIG. 7. The graphical user interface (GUI) illustrated in FIG. 11 includes a number of visual display elements and fields that allow a user to define the shape of a light source in the optical model. The shape of a light source refers to intensity of light at locations across the surface of the light source. With reference to the optical model, the shape defines the likelihood of a photon emanating at any point on the light source. Thus, the light source shape refers to a frequency distribution of photons that may emanate from the light source. The light source shape defined with the user interface in FIG. 11 does not necessarily correspond to the geometric shape of the light source. The geometric shape of the light source is assumed to be circular.

The embodiment shown in FIG. 11 allows the user to define the light source as “Gaussian”, “Pill Box”, or some other shape definition. Gaussian and Pill Box shapes may be represented with analytical functions in the optics-modeling module 339. Advantageously, the user is not limited to analytical models of light source shape, and is able to load a shape profile from a file stored in memory. The use may also manually input shape data. A frequency distribution plot is provided that graphically illustrates the light source shape. The user is also able to define a reference coordinate system.

The GUI in FIG. 11 includes a window 1100 that presents information and visual prompts to the user to allow the user to input the light source shape and location definition. A “definition” frame 1104 provides a number of subframes, fields and prompts that allow the user to define the light source shape. A “shape options” subframe 1108 includes visual display elements, such as a “Gaussian” radio button 1112, a “Pill Box” radio button 1114, and an “other” radio button 1116, whereby the user can choose a light source shape.

A sigma (σ) entry field 1120 is used to enter an R.M.S. value associated with a Gaussian shape when the Gaussian radio button 1112 is selected. Also when the Gaussian radio button 1112 is selected, a half-width entry field 1124 enables the user to enter a “half-width” value associated with the selected Gaussian shape.

The half-width entry field 1124 is also used when the Pill Box radio button 1114 is selected for a Pill Box light source shape. The sigma (σ) entry field 1120 and the half-width entry field 1124 are in units of milliradians (mrads) in the specific embodiment shown in FIG. 11. While the embodiment shown in FIG. 11 illustrates two specific analytically defined shapes, i.e., Gaussian and Pill Box, it is to be understood that other analytically defined shapes may be presented to the user as selectable shape options in other embodiments that fall within the scope of the present invention. By way of example, and not limitation, other possible shapes may be Poisson, Gamma, or Weibull, among others, depending on the particular application.

When the “other” radio button 1116 is selected by the user, an “other” subframe 1128 is activated to allow the user to enter light source shape definition data from user selectable sources. The “other” subframe 1128 includes a “from file” radio button 1132 and a “user-defined” radio button 1136. When the user selects the from file radio button 1132, a “load from file” button 1138 is provided to the user to select a file with light source shape profile data defining the light source shape. The data in the file may be in any format recognizable by the optics-modeling module 339, and preferably contains intensity data at a number of locations on the light source. Intensity as used herein refers to the relative probability that a photon will emanate from a given point on the light source. Files that may be selected by the user via the load from file button 1138 are typically in memory within or coupled to the computer system 310 executing the solar optics-modeling module 339 illustrated in FIG. 3.

The user may select the “user-defined” radio button 1136 to manually define parameters for selected points on the surface of the light source. When the “user-defined” radio button 1136 is selected, point data may be manually entered in a table, such as a “point data” entry table 1146. A visual display element, such as a “number of points” entry field 1142, becomes accessible to facilitate definition of light source points. The number of points entry field 1142 enables the user to enter a number of points on the light source to be manually defined.

The positions of points on the surface of the light source are defined in terms of angles. The point data entry table 1146 has two columns, an “angle” column 1150, and an “intensity” column 1154. The angle column 1150 includes entry fields for entering an angle value that defines a distance that a point on the surface of the light source lies from the center of the light source surface. In the embodiment of FIG. 11, it is assumed that the light source is circular from the perspective of the optical device that will be receiving the rays. The angle value is the angle formed by the intersection of a perpendicular line extending from the center of the light source to a point on stage 1 of the optical device and a line extending from the point being defined on the light source to the same point on stage 1.

The intensity column 1154 has fields for entering an intensity level associated with each of the angle fields in the angle column 1150. To illustrate, as shown in FIG. 11, at an angle of 0 mrads (i.e., the center of the light source), the associated intensity is 269. To further illustrate, at an angle of 2.33 mrads, the intensity is 266, and so on. Each intensity value defines intensity on a circle having a radius defined by the associated angle, wherein the circle is centered on the center of the light source.

The intensity values entered in the intensity column 1154 are related to the type of light source being modeled and are chosen to define the relative distribution of light rays that may emanate at a particular point on the light source. Thus, the particular values that the user enters in the intensity column 1154 are most important as they relate to each other in defining a distribution of light rays across the surface of the light source. The point data entry table 1146 may include a horizontal scroll bar 1158 and a vertical scroll bar 1162 for scrolling through user defined data and accessing other fields in the table.

The “define” frame 1104 may also include a “clearing” visual display element, such as the “clear all” button 1166, whereby the user may clear all data in the point data entry table 1146. After the user enters user-defined data in the point data entry table 1146, the user may select a “saving” visual display element, such as the “save” button 1170 to save any light source point data that the user may have defined. When the user selects the save button 1170, the user may be prompted to enter a file name and location in memory of the computer system 300 (FIG. 3) to which data in the point data entry table 1146 will be saved. When the user enters the GUI window 1100 at a later time, the user may open the file to which prior point data was saved. When the file is opened, the point data is read from the file and displayed in the point data entry table 1146.

After the user selects a light source definition and/or defines light source point data in the “defining” frame 1104, the user may select a show visual display element, such as the “show plot” button 1174 to display a frequency plot 1181 of the light source based on the definition of the light source. As shown in FIG. 11, the light source shape may be plotted in a light source shape subframe 1178. The light source shape is plotted in units of mrads along the x-axis 1180 and probability along the y-axis 1182. The probability ranges from zero to one, and is obtained from the light source shape previously defined. For example, as illustrated the manually entered intensity data in the point data entry table may be normalized (i.e., converted to a range from zero to one) by dividing each of the intensity values by the largest intensity value. The angle at which the probability is zero (e.g., around plus or minus 11 mrads) defines a boundary of the light source. The probability of a ray emanating from beyond the boundary is zero.

The light source definition GUI 1100 may also have a coordinate reference subframe 1183, whereby the user may define a global coordinate reference system. In one embodiment, the coordinate reference system subframe 1183 has a “global coordinates” radio button 1184, and a “seasonal coordinates” radio button 1186. If the user selects the global coordinates radio button 1184, the user may enter (x, y, z) reference coordinate values in an x-entry field 1188, a y-entry field 1190, and a z-entry field 1192 respectively. If the user selects the seasonal coordinates radio button 1186, the user may then enter a latitude, day of year, and local hour in fields 1188, 1190, and 1192, respectively. In one embodiment, if the user enters seasonal coordinates, the seasonal coordinates are used to calculate global coordinates in (x, y, z) coordinate form. The global coordinate reference system is used to define the stage and element position and orientation and during the ray-trace operation to determine ray locations and directions.

After the user has defined the light source shape and the global coordinate reference system, the user may select a “done” button 1194 to indicate that the user is finished defining the light source shape and the global coordinate reference system. When the user selects the done button 1194, the light source definition data and the global coordinate reference system data are saved in memory, and the GUI shown in FIG. 6 is presented for the user to continue defining the optics model. An “exit” button 1196 enables the user to exit the light source shape defining GUI 1100 without saving any light source shape definition data or global reference coordinate system data that may have been entered into the GUI 1100.

FIG. 12 illustrates a user interface that may be used in conjunction with the optical model defining operation 704 shown in FIG. 7 to define optical stage and element geometry, location, orientation, and properties. The user interface includes a window 1200 that provides a mechanism by which a user may define models for one or more stages of an optical system. The window 1200 further provides a mechanism for the user to define models for one or more optical elements associated with each of the stages. The stages and elements that are defined by the user using the window 1200 will be stored for use during ray-tracing.

The geometry, position, and optical properties defined using the window 1200 are primary determinants of how rays interact with the stages and elements. During the ray-trace operation discussed below, the element location, orientation, and properties will be used to calculate ray intersection with elements, and new directions after intersection. The location and orientation of an optical element will determine where a ray will intersect the element, if at all. The orientation, location, and optical properties (discussed below) will determine an angle at which the ray will reflect off of or transmit through the element. The properties will also determine whether the ray will be absorbed by the element.

The window 1200 may have an input frame 1202 having source visual display elements, such as a “from file” button 1204 and a define button 1206. If the user wants to input geometry and property data from a file, the user selects the “from file” button 1204 using an input means, such as the mouse 361 and/or keyboard 362 (FIG. 3). If user wants to manually enter geometry and property data, the user may select the define button 1206. The input frame 1202 also has an exit button 1208 whereby the user may exit the property entry window 1200.

The window 1200 includes a data entry table 1210 wherein the user enters stage and element property, geometry, location, and/or orientation data. The element data is shown in a number of columns. Each column includes a particular type of element data. An element number column 1214 shows each element number associated with a stage indicated with a stage identifier tab 1212. In the row of each element number is property data corresponding to that element. To define the elements in a stage, the user selects one of the tabs 1212, and then enters property data for each of the elements associated with the selected stage.

Before the user enters element data, the user enters stage data. The stage data includes a stage count, and stage location and orientation data. The stage count refers to the number of stages to be modeled. In one embodiment, each of the stages to be modeled has an associated coordinate reference system defined by location and orientation data entered by the user.

Referring to the stage count, a stage count entry field 1224 allows the user to enter the number of stages to be modeled. In the embodiment, the number of stages entered does not include the receiver stage, because it is assumed that there will be at least one stage that ultimately receives all the rays in the optical model. The number of stages entered in the stage count entry field 1224 is the number of stages not including the receiver. The number of stages may also include one or more virtual stages. Virtual stages are abstractions from the actual optical system being modeled, whereby the user may analyze rays at any point in the path within the optical system. For example, a user may define a virtual stage as being a planar region between two of the actual optical stages within the system. Using the virtual stage, the user may later view ray-trace plots at the virtual stage. A ray-trace plot at a virtual stage may be understood as being a flux map of rays through that planar region defined by the virtual stage.

A stage number entry field 1228 allows the user to select which stage to define. When the user uses the stage number entry field 1228, one of the tabs 1212 is activated so that the user may enter element property data in the property entry table 1210. A stage number selector 1232 within the property entry table 1210 similarly allows the user to select among the stages to be defined. A stage type frame 1236 provides visual display elements, such as an optical stage radio button 1240, and a virtual stage radio button 1244. The stage type frame 1236 provides options to the user to define each stage as being either an actual optical stage within the system that's being modeled or a virtual stage. A file entry field 1248 is the field where a user types the name of the file to input data from a property data file. A modified indicator 1252 is activated when the data in the property entry data table 1210 has been modified.

In one embodiment, the stage location and orientation information is entered with the light source reference coordinate system (i.e., the global coordinate reference system selected using the coordinate reference system selection subframe 1183 in FIG. 11) as a reference. The user enters stage origin coordinates in stage origin coordinate entry fields 1216. The stage origin coordinate entry fields 1216 include an “x” field, “y” field, and “z” field for entering (x, y, z) coordinates for the origin of the stage. As illustrated in FIG. 12, the (x, y, z) origin values are (0, 0, 0), which means that the origin of the stage is the same as the origin of the global coordinate reference system.

A user enters stage orientation information with stage axes orientation entry fields 1218. The stage axes orientation entry fields 1218 include aim-point information and z-rotation information. The aim-point information designates what direction the z-axis of the stage is aiming. The z-rotation value designates rotation of the stage z-axis around the z-axis of the coordinate reference system. The aim-point includes three values: the leftmost three entry fields of the stage axes orientation entry fields 1216. As shown in FIG. 12, the aim-point has values (0,0,1). An aim-point of (0,0,1) means that the z-axis of the stage coordinate reference system point in a direction defined by a line extending from the origin of the global coordinate reference system to a point of (0,0,1) in the global coordinate reference system. Thus, the aim-point (0,0,1) designates the z-axis of the stage coordinate reference system is the same direction as the z-axis of the global coordinate reference system. The stage (or element) coordinate system is finally rotated around its z-axis by the z-rotation angle in degrees in a clockwise direction. In one embodiment, one coordinate system may be defined with reference to another coordinate system using equations (3)-(5) shown and discussed in detail below.

After the user defines the stage count, location, and orientation, the element property data may be entered in the data entry table 1210. Part of the element property data is the element origin and orientation information. The second and third columns of the property entry table 1210 have fields for entering (x, y, z) origin for each element in this stage and (x, y, z) aim fields for entering element orientation information, respectively, with the stage origin as a reference. A column labeled aperture type allows the user to enter an aperture type for each element in the element column 1214. A z-rotation column allows the user to further orient the element axes by designating rotation of the element coordinate axes about the z-axis of the element. A surface type column allows the user to enter surface type information. In one embodiment, the user is able to select among aperture types shown in Table 1. Also shown in Table 1 are parameters and codes that the user enters for each aperture type.

TABLE 1

| Code | Aperture Type | Parameters |
|---|---|---|
| H | Hexagon | Diameter of circle |
| | | encompassing hexagon |
| R | Rectangle | Height and width of rectangle |
| C | Circle | Circle radius |
| T | Equilateral Triangle | Diameter of circle |
| | | encompassing triangle |
| S | Single Axis Curvature Section | Curvature in one dimension |
| A | Annular (Donut) | Inner radius, outer radius, |
| | | angle (0°-360°) |

In an embodiment, the user can select among the surface types and their associated codes and parameters that are shown in Table 2.

TABLE 2

| Code | Surface Type | Parameters |
|---|---|---|
| S | Hemisphere | First curvature, second curvature |
| P | Parabola | First curvature, second curvature |
| F | Flat | None |
| C | Conical | Half-angle of cone |
| H | Hyperboloid | First curvature, second curvature |
| E | Ellipsoid | Major radius, minor radius |
| G | General | Analytical expression |
| Z | Zernike | Parameters for Zernike equation |
| V | VSHOT | Filename of experimental VSHOT data |

The surface type and aperture type are used during the ray-trace process to determine where a ray will intersect the surface of the element, whether the ray will hit within the aperture, and, if so, a new direction for the ray after the ray hits the surface. The surface type and aperture type define every location on the element surface in (x,y,z) coordinates and slope angles at each point. The coordinate and slope data is used to determine an intersecting ray's direction after intersecting the element.

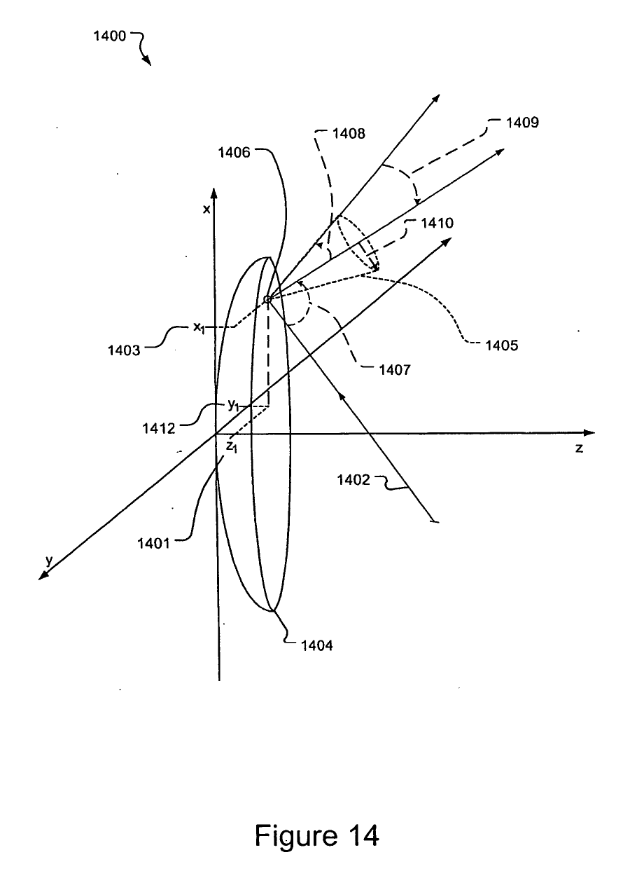

A Zernike surface type is given by equation (1):

$$Z ( x , y ) = {\sum }_{i = 0}^{N} {\sum }_{j = 0}^{i} {B}_{i j} {x}^{j} {y}^{( i - j )} , \qquad ( 1 )$$

where Bᵢⱼ is a coefficient, ‘i’ is an index to the first summation series, ‘j’ is an index to the second summation series, N is the “order” of the equation. N determines how many terms there are in the equation. Variable ‘x’ is the x direction of a coordinate, and ‘y’ is the y direction of the coordinate, and Z is the z direction of the coordinate. FIG. 14 illustrates a Zernike ‘z’ value, z₁ 1401, which may be calculated with equation (1) for a given x value, such as x₁ 1403 and a given y value, such as y₁ 1412. To obtain the slope data necessary for ray intersection analysis, a derivative is taken of the Zernike equation when a Zernike surface type is used.

A horizontal scroll bar 1220 allows the user to scroll to other columns having entry fields for other properties for each element. Other columns in the property entry table 1210 are an optic type column (not shown but discussed below) and a properties column (not shown), which allows the user to designate a file having other element properties defined therein. Other properties that may be defined for each element are described in more detail with reference to FIG. 13. In the properties column, a property filename may be entered to identify a file that has property data for each element in the element column 1214.

A filename may be entered identifying a surface type file having experimentally measured data characterizing an existing optics system. In one embodiment, the surface type file contains VSHOT data. A VSHOT file contains parameters for a Zernike equation from which a ‘z’ value and a slope analytically may be determined at every (x,y) coordinate on the surface of the optical element. The VSHOT file also contains raw residual slope error values in the x and y direction at each coordinate (x,y) on the surface of the element. The slope errors are combined with the analytically derived slopes to create corresponding actual slope values. Experimental raw slope data, such as the slope data derived from VSHOT analysis, may be preferable to analytically derived slopes (e.g., derivatives of the Zernike equation) because the raw slope values may provide a more realistic model and therefore more accurate results associated with ray/element interaction in existing systems. The VSHOT data file describes the surface contour of an element and so there could be a separate file for each element.

Other optical system measurement systems providing data similar to the VSHOT data are known in the art. Thus, other embodiments of the optical modeling module 339 may accept surface type files having other types of suitable measurement data. Examples of other techniques are interferometric analysis, Hartman Optical Testing, and Foucault analysis. Any measurements may be used that provide analytical and/or slope error data at each point on the element.

An ‘optic types’ column (not shown) in the property entry table 1210 can be scrolled to using the horizontal scroll bar 1220. The optic types column may contain optic type descriptors for each of the elements in the element column 1214. Exemplary optic types and associated codes are shown in Table 3.

TABLE 3

| Optic type | Code |
|---|---|
| Reflection | 2 |
| Refraction | 1 |
| Diffraction | 3 |

An element selector, such as an element checkbox 1215, may be provided for each element in the element column 1214. Using the element checkboxes 1215, the user may choose elements to be modeled during a ray-trace operation. When a checkbox 1215 is not checked (e.g., element number 5), the associated element is not included in the ray-trace operation. Alternatively, when a checkbox is checked, the associated optical element is used in the ray-trace. Advantageously, using the element checkboxes 1215, the user can perform a ray-trace with or without particular optical elements included in the mode to analyze how any particular element affects the ray-trace.

A visual display element, such as a trace-through checkbox 1237, may be provided for enabling the user to trace a ray through the model even when the ray misses one or more of the stages. When the trace-through checkbox 1237 is checked, any ray that misses a stage will continue to be traced through subsequent stages during a ray-trace operation. When the trace-through checkbox 1237 is not checked, rays that miss a stage are eliminated from future tracing in the ray-trace operation. The trace-through checkbox 1237 may be particularly useful in modeling optical systems wherein rays may miss one stage and still hit other stages (i.e., remain in the optical system).

When the user has finished entering stage and/or element property data, the user may select from a “done” button 1256, a save button 1260, or a clear button 1264. When the user selects the done button 1256, the data that was entered is saved in RAM and will be used during the ray-trace operation. The save button 1260 enables the user to save any data in the property entry table 1210 to a file in long-term memory. When the user selects the save button 1260, he/she may be prompted to enter a file name. When the user selects the clear button 1264, any data that was entered in the property entry table 1210, will be cleared.

A data structure having optical element properties for a front and backside of an optical element is illustrated in FIG. 13. The property data structure 1302 is stored in memory media, such as any memory device shown in the computer system 310 (FIG. 3), and is stored in a binary encoded format recognizable by the processing unit 320. The front properties data structure 1304 and the back properties data structure 1306 have the same property fields describing various properties of the front and backsides of an optical element.

An optical surface number field 1308 indicates either the front or backside of the optical element. An indices of refraction field 1310 provides refraction data for the associated side for determining angles of refraction. The indices of refraction field 1310 is used by the model execution module 420 to determine a direction of a ray after it has been refracted by either the front or the back surface of the optical element. An aperture stop field 1312 has data defining a grating type for the surface if applicable. A diffraction order field 1314 has data defining an order of diffraction associated with the surface, if applicable. The diffraction order field 1314 may be used for surfaces such as prisms that have diffractive properties and disburse different frequency components of light rays.

A grating spacing field 1316 has grating spacing polynomial coefficients for use with surfaces that include a grating. A reflectivity field 1318 has data defining the reflective properties of the surface. In one embodiment, the reflectivity field 1318 is a percentage representing a percentage of rays that will be reflected upon impact with the surface. For example, if the reflectivity field 1318 has a percentage of 96%, 96 rays out of every 100 that hit the surface will be reflected, and the other 4 will be absorbed. A transmissivity field 1320 has data defining transmissive properties of the surface.

In one embodiment, the transmissivity field 1320 is a percentage representing a percentage of rays intersecting the surface that will continue through the surface. For example, if the transmissivity field 1320 is 90%, the likelihood that a ray intersecting the surface will transmit through the surface is 90%. The reflectivity field 1318 and the transmissivity field 1320 are related to the optics type designated in the element geometry table 1210 (FIG. 12), and the optics type column (not shown) wherein the element may be designated as being reflective or transmissive (see Table 3). If the element is designated as being of a reflective type, the reflectivity field 1318 will be used. If the element type is designated as being transmissive, the transmissivity field 1320 will be used.

In one embodiment, the values in the reflectivity field 1318 and the transmissivity field 1320 are used with a random number generator. The random number generator generates a number between zero and one. If the generated number is less than or equal to a percentage value in the reflectivity field 1318, and the optics type is reflective, an intersecting ray will be reflected. If the randomly generated number is greater than the percentage in the reflectivity field 1318, the ray will be absorbed.

An RMS slope error field 1322 is the RMS of all slope errors at every point on the surface of the optical element. An RMS specularity error field 1324 includes data defining a specularity property for the surface of the element. Specularity is a property of each point on the surface of the element that may augment the manner in which a ray reflects off the element. The RMS specularity error field 1324 represents the root mean square of all specularity errors at every point on the surface of the element. A distribution type field 1326 designates a frequency distribution associated with the interaction of a ray with the surface of the element.

In one embodiment, the distribution type field 1326 may be either a Pill Box distribution or a Gaussian distribution. The RMS slope error field 1322, the RMS specularity error field 1324, and the distribution type field 1326 are used in combination to emulate a ray's interaction with the surface of the optical element. To illustrate how the RMS slope error field 1322, the RMS specularity error field 1324, and the distribution type field 1326 may be used to determine a ray's interaction with an element. FIG. 14 depicts a ray 1402 impacting an inner surface of an optical element 1404. The ray 1402 intersects the element 1404 at an intersection point 1406 and reflects off the element in a direction having x, y, and z directional components.

In the embodiment, Snell's law is used to calculate a preliminary angle of reflection 1407. The preliminary angle of reflection 1407 is calculated assuming no slope error or specularity error exists in the optical element 1404. Due to slope error and specularity error (discussed above) associated with the optical element 1404, the angle of reflection 1407 may be perturbed. A perturbation angle 1409 may be calculated using the RMS slope error 1322 and the RMS specularity error 1324 and the distribution type. In the embodiment, the perturbation direction falls somewhere on a conical surface 1405 centered about the direction line defined by the preliminary reflection angle 1407 derived by Snell's law. The half-width of the distribution is a combination of A & B as shown in equation (2):

Half−width=\sqrt{4A²+B²},

where A is an RMS slope error (e.g., RMS slope error field 1322), B is an RMS specularity error (e.g., RMS specularity error field 1324), and the units are in milliradians (mrads). The location of the perturbed direction around the cone is determined randomly.

The distribution type 1326 may be any distribution known in the art. A random number generator may be used to randomly select a number in the distribution. Random number generators are known in the art and easily implemented using a computer and a random number generator algorithm. After a random number is selected from the distribution, the number may be scaled, depending on the size of the conical half-angle 1408.

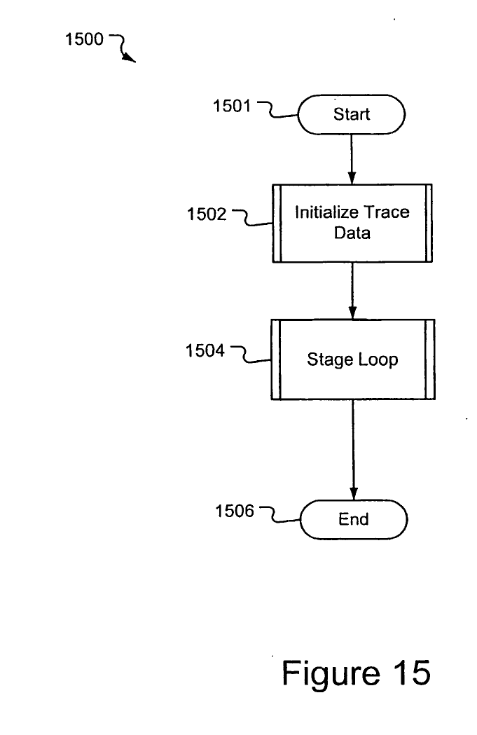

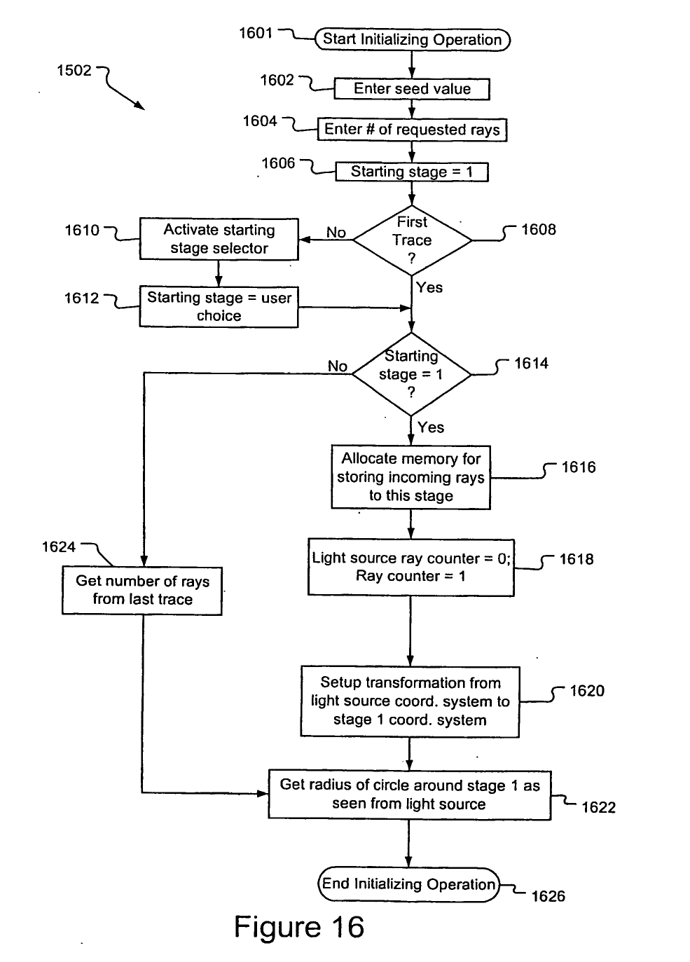

FIG. 15 is a flowchart illustrating an embodiment of an executive trace operation that may be employed by the optics-modeling module 339 of FIG. 3. In one embodiment, the executive trace operation 1500 is entered when the user selects the trace button 630 (FIG. 6). The executive trace operation 1500 begins with a start operation 1501. An initializing operation 1502 then initializes certain parameters required to conduct the ray-tracing operation. The ray-tracing parameters that are initialized are discussed in more detail with regard to FIG. 16. After the initializing operation 1502, a stage looping operation 1504 performs a ray-tracing operation by looping through each of the stages defined earlier by the user (e.g., via GUI 1200 in FIG. 12). The staging loop 1504 models or emulates rays as they pass or travel through the optical system being modeled. The staging loop 1504 may implement a Monte Carlo method. Monty Carlo methods generally include any statistical simulation utilizing random numbers to perform this simulation. After the stage looping operation 1504, the executive trace operation 1500 ends at end operation 1506.

An embodiment of the initializing operation 1502 is shown in a flowchart in FIG. 16. After starting operation 1601, an entering operation 1602 enables the user to enter a seed value for the random distribution associated with the light source. An entering operation 1604 enables the user to request a number of rays that will be generated from the light source and used during the ray-tracing operation. Pseudo-random number generator algorithms require an initializing value to begin generating pseudo-random numbers. This value is the seed. The requested ray value is the number of rays that the user wishes to be traced from stage 1.

An equalizing operation 1606 sets a starting stage variable equal to one. A determining operation 1608 determines whether the optical model being traced has been traced (i.e., modeled) previously. If the model has been traced previously, initializing operation 1502 branches no to an activating operation 1610. The activating operation 1610 enables the user to select a starting stage other than stage one. An equalizing operation 1612 sets the starting stage variable equal to the user's selection. If, in the determining operation 1608, it is determined that the optical model being traced has not been traced previously, the operation 1502 branches “yes” to a determining operation 1614. After the user selects a starting stage in the equalizing operation 1612 the operation 1502 enters the determining operation 1614.

The determining operation 1614 determines whether the starting stage is stage one. If it is determined that the starting stage is stage one, the initializing operation 1502 branches “yes” to an allocating operation 1616. The allocating operation 1616 allocates memory for storing incoming rays to stage one. The allocating operation 1616 determines the number of rays requested from operation 1604 and reserves memory for each of those rays to be traced during the tracing operation. An initializing operation 1618 sets a light source ray counter equal to zero, and a ray counter equal to one.

The light source ray counter is used to count the number of rays that have been generated from the light source. The light source ray counter keeps track of how many rays had to be traced from the source to stage 1 in order to achieve the requested number of rays from stage 1. A set-up operation 1620 sets up a transformation from the global coordinate reference system (entered in the window 1100 of FIG. 11) to the stage one coordinate system.

Transforming a (x, y, z) coordinate from a first coordinate system (e.g., global coordinate system) to a second coordinate system (e.g., first stage coordinate system) may be implemented with a mathematical algorithm based on the global coordinate system entered and the stage coordinate reference system 1216 entered in the stage/element geometry window 1200 (FIG. 12).

In one embodiment, transformation from a first coordinate system to a second coordinate system involves employing direction cosines in combination with translation between the origins of any two coordinate systems (e.g., global coordinate system to stage coordinate system, stage coordinate system to stage coordinate system, stage coordinate system to element coordinate system, etc.). The direction cosines provide degrees of rotation of the axes of the second coordinate system relative to the axes of the first coordinate system. Transformation equations that may be used in this embodiment are shown in equations (3) through (5) below.

$$\begin{matrix}R = [ \begin{matrix}( \begin{matrix}cos α cos γ + \\ sin α sin βsin γ\end{matrix} ) & - cos β sin γ & ( \begin{matrix}- sin α cos γ + \\ cos α sin β sin γ\end{matrix} ) \\ ( \begin{matrix}cos α cos γ - \\ sin α sin βsin γ\end{matrix} ) & cos β cos γ & ( \begin{matrix}- sin α sin γ - \\ cos α sin β cos γ\end{matrix} ) \\ sin α cos β & sin β & cos αcos β\end{matrix} ] , & ( 3 ) \\ [ \begin{matrix}\begin{matrix}{X}_{0} \\ {Y}_{0}\end{matrix} \\ {Z}_{0}\end{matrix} ] = R [ \begin{matrix}\begin{matrix}{\overline{X}}_{0} - {\overline{x}}_{0} \\ {\overline{Y}}_{0} - {\overline{y}}_{0}\end{matrix} \\ {\overline{Z}}_{0} - {\overline{z}}_{0}\end{matrix} ] , and & ( 4 ) \\ [ \begin{matrix}\begin{matrix}k \\ l\end{matrix} \\ m\end{matrix} ] = R [ \begin{matrix}\begin{matrix}\overline{k} \\ \overline{l}\end{matrix} \\ \overline{m}\end{matrix} ] , & ( 5 )\end{matrix}$$

wherein (\overline{x}ₒ, \overline{y}₀, \overline{z}₀) represents the origin of the stage coordinate system, (\overline{X}₀, \overline{Y}₀, \overline{Z}₀) represents a point in the global coordinate system, (X₀, Y₀, Z₀) represents the same point in the stage coordinate system, R represents a rotation matrix, α represents an angle of rotation of the stage coordinate system about the y-axis, β represents an angle of rotation of the stage coordinate system about the x-axis, and γ represents an angle of rotation of the stage coordinate system about the z-axis, (k, l, m) represents direction cosines in the stage coordinate system, and (\overline{k}, \overline{l}, \overline{m}) represents direction cosines in the global coordinate system.

As will be apparent to those skilled in the art, the equations (3)-(5) may be used to transform a location or direction in one coordinate system to a location or direction in another coordinate system. During the ray-trace operation, discussed in detail below, ray locations and directions are transformed using implementations of equations (3)-(5).

Referring again to FIG. 16, an obtaining operation 1622 obtains the maximum radius of a circle around stage one as seen from the light source. The circle around stage one is used to select locations within the circle where light rays from the light source will intersect stage one. The process of generating rays from the light source that intersect stage one within the circle around stage one is discussed in more detail below.

If in the determining operation 1614 it is determined that the starting stage is not stage one, operation flow 1502 branches “no” to an obtaining operation 1624 wherein the number of rays from the last trace performed is determined. The obtaining operation 1624 determines the number of rays emanating from the stage immediately prior to the starting stage that were saved during the last trace. After the obtaining operation 1624, the obtaining operation 1622 is entered. As discussed above, the obtaining operation 1622 obtains a radius of the smallest circle required to encompass stage one as seen from the light source. The first time through the operation 1502 the obtaining operation 1622 calculates the radius of the circle. Subsequent iterations through the operation 1502 reuse the circle that was calculated during the first trace through. The initializing operation 1502 ends at end operation 1626.

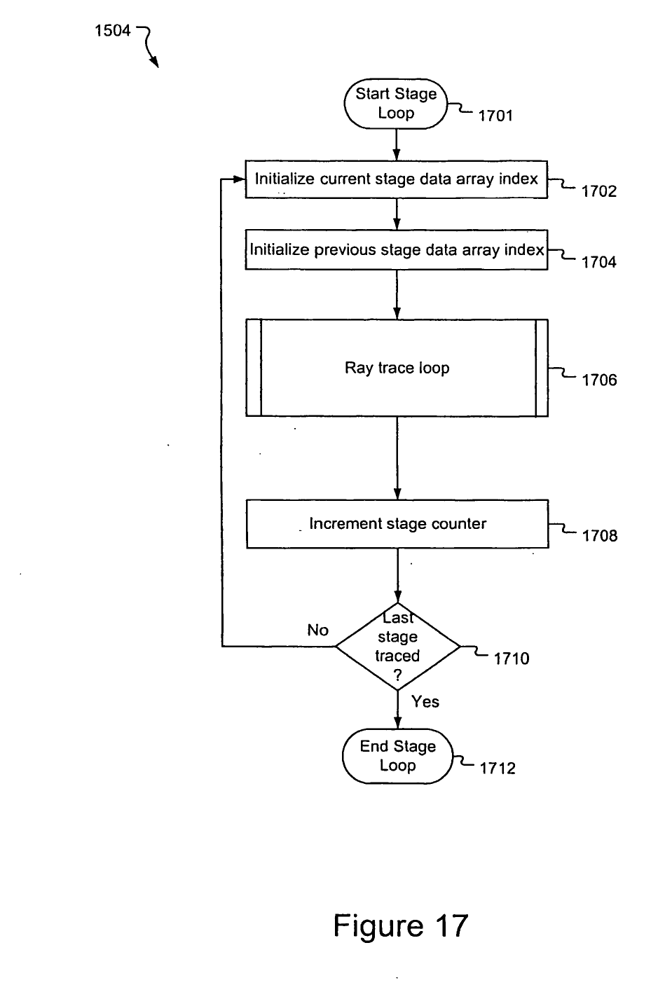

A particular embodiment of the stage looping operation 1504 is depicted in a flowchart in FIG. 17. In this embodiment, rays are modeled in the computer (e.g., computer 310 in FIG. 3) as objects, variables, or structures that have parameters defining the modeled ray. The ray parameters include, but are not limited to, the ray position and direction within a coordinate system. In general, trace execution involves generating a ray at a position at the light source, determining a direction of the ray path from the light source to the first stage, determining a location of intersection on the stage (if any), and determining an angle of departure from the stage. After the first stage, the ray is traced through subsequent stages until the ray either expires or reaches the final stage.

In embodiments of the trace execution operations shown in FIGS. 17-22, an array is used to store and update ray variables as the trace executes. The ray parameters, such as location and direction, are updated based on their interaction with each stage in the model. The embodiments include one array, and two separate indices that refer to ray data held in the array. The array is used to keep track of ray locations and directions as a ray is traced from one stage (or light source) to another stage. A current stage index is used to read ray information from the previous stage to calculate updated ray information related to the current stage. A previous stage index is used to write updated ray information back to the array. The new location and direction data then becomes the previous stage data for the next stage trace. Using one array in this way saves valuable memory space. Those skilled in the art may recognize other implementations that fall within the scope of the present invention.

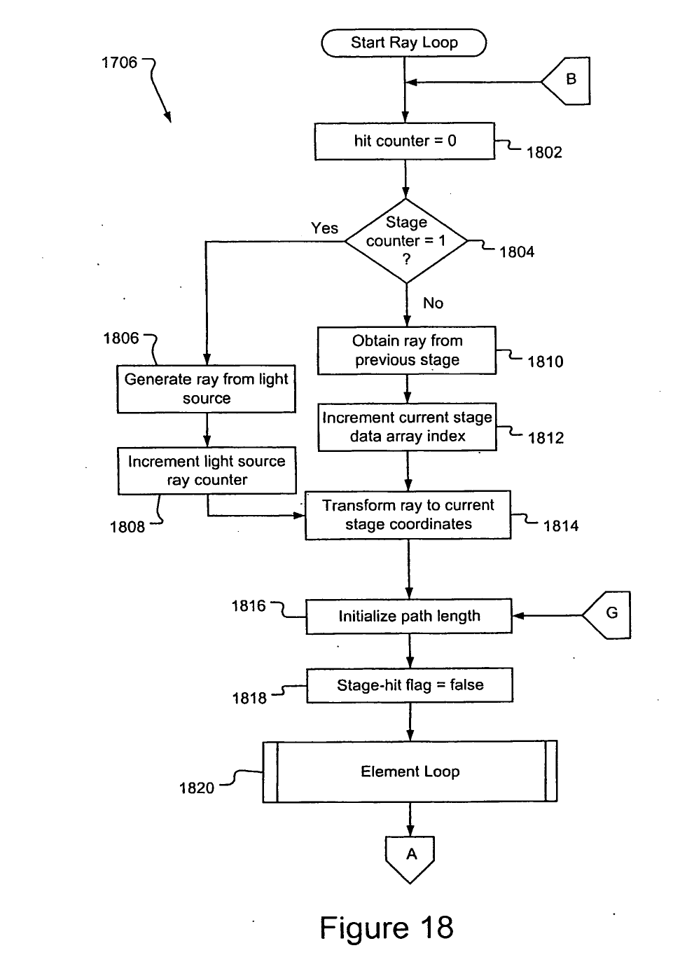

Referring now to FIG. 17, after a starting operation 1701, an initializing operation 1702 initializes a current stage data array index (i.e., set to the beginning of the current stage data array). An initializing operation 1704 initializes a previous stage data array index to the start of the previous stage data array. A ray-trace looping operation 1706 then traces rays through the current stage. The ray-trace looping operation 1706 is discussed in more detail with regard to FIGS. 18-21.

After the ray-trace looping operation 1706, an incrementing operation 1708 increments a stage counter. The stage counter refers to the current stage used for ray-tracing the next iteration through the stage looping operation 1504. A determining operation 1710 determines whether the last stage in the model has been traced. The determining operation 1710 compares the stage counter to the maximum number of stages in the model, and if the stage counter is greater than the maximum number of stages in the model, the stage looping operation 1504 branches “yes” to an end operation 1712. If the determining operation 1710 determines that the last stage has not been traced, the looping operation 1504 branches “no” back to the initializing operation 1702.

An embodiment of the ray looping operation 1706 is shown in FIGS. 18-21. The ray looping operation 1706 begins by initializing a hit counter valued to zero in an equalizing operation 1802. A determining operation 1804 determines if the current stage is stage one. If the stage counter is equal to stage one in operation 1804, looping operation 1706 branches “yes” to a generating operation 1806 wherein a ray is generated from the light source. The generating operation 1806 randomly chooses a point within the circle previously defined in obtaining operation 1622, preferably using a pill box distribution. The generating operation 1806 employs a random number generator to determine a random point in the circle surrounding stage one.

In one embodiment, the generating operation 1806 creates or instantiates a modeled ray in the form of an object, structure, variable in computer memory. The modeled ray includes parameters such as, but not limited to, a location value and a direction value, that characterize the modeled ray. The modeled ray may be subsequently operated on to adjust the parameters based on interaction with the modeled stages and elements.

An incrementing operation 1808 increments the light source ray counter. If the determining operation 1804 determines that the current stage is not stage one, the looping operation 1706 branches “no” to an obtaining operation 1810. In the obtaining operation 1810, a ray from the previous stage (i.e., the stage immediately before the current stage). Whenever the current stage is greater than one, ray data from all stages is saved prior to entering the ray looping operation 1706. Thus in the obtaining operation 1810, when the current stage is not the first stage, a ray is selected from the previous stage that was previously stored. An incrementing operation 1812 increments the current stage data array index. A transforming operation 1814 transforms the ray obtained from operation 1810 into the stage coordinates of the current stage. As discussed above in detail, in one embodiment, transforming a ray into stage coordinates may be implemented using equations (3) through (5).

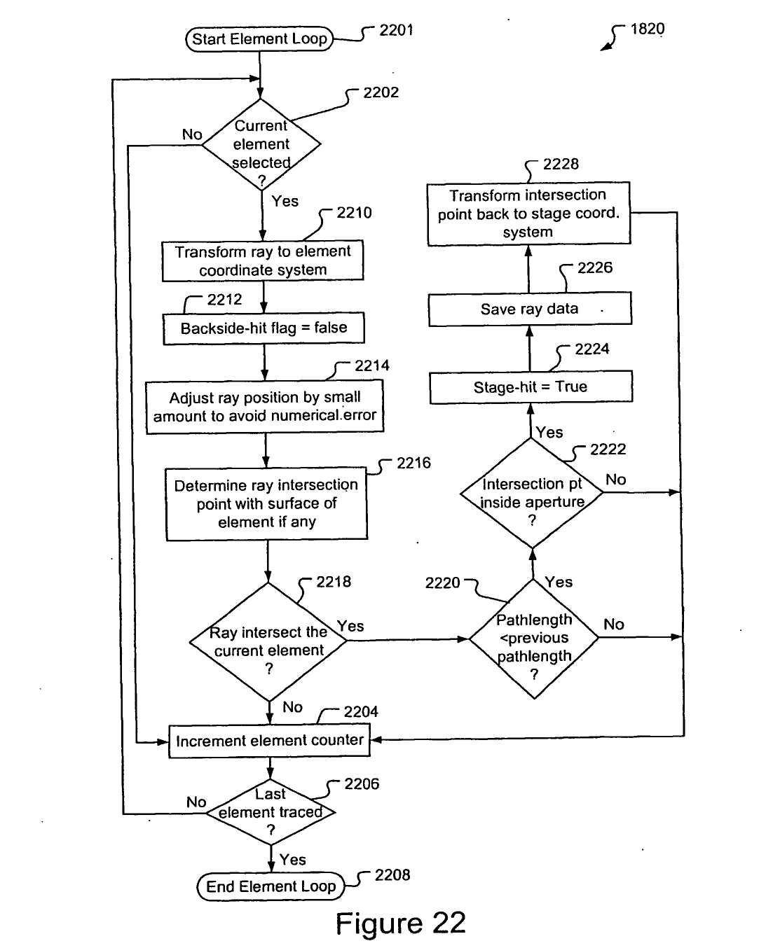

After the incrementing operation 1808, the looping operation enters the transforming operation 1814. After the transforming operation 1814, an initializing operation 1816 initializes a path length value. The path length value is the path length from the light source or the previous stage to the current stage. The path length value is used to determine whether an element in the stage is the first element to be intersected by the ray. In initializing operation 1818 initializes a stage-hit flag to false. The stage-hit flag is used to monitor whether the ray has hit an element in the current stage. After the initializing operation 1818, an element looping operation 1820 traces the ray through all the elements in the current stage. The element looping operation 1820 is discussed in more detail with respect to FIG. 22.

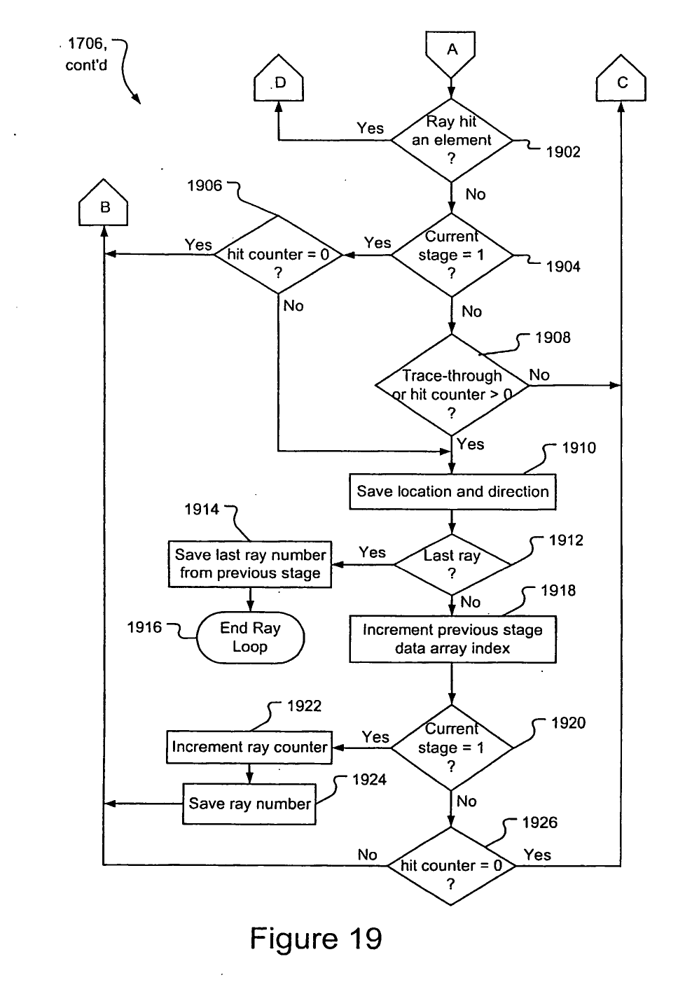

The ray looping operation 1706 continues as shown in FIG. 19. After the element looping operation 1820, a determining operation 1902 determines if the ray hit an element within the current stage. The determining operation 1902 tests the stage-hit flag to determine whether the flag is true. If the ray hit an element in the current stage, the ray looping operation 1706 branches “yes” to an archiving operation 2006, discussed in more detail below. If the ray did not hit any elements in the current stage, the ray looping operation branches “no” to a determining operation 1904. The determining operation 1904 determines whether the current stage is stage one.

If the current stage is stage one, the ray looping operation 1706 branches “yes” to a determining operation 1906 wherein it is determined whether the hit count is equal to zero. The ray is traced through the stage, over and over again until it satisfies the criteria that “no” elements were hit (i.e., “stage hit” flag is false). Up to that point, however, the ray may have had one or several hits (i.e., non-zero “hit count”). In this embodiment, the ray has to ultimately be traced through all the elements one last time to ensure that it has missed all the elements and is now on its way out of the stage. The combination of the two variables, “stage hit flag” and “hit count,” determines whether the ray completely missed the stage or in fact hit the stage somewhere before moving on to the next stage. If it is determined that the hit count equals zero in the determining operation 1906, the ray looping operation 1706 branches “yes” to initializing operation 1802.

If, in the determining operation 1904, it is determined that the current stage is not equal to one, the looping operation 1706 branches “no” to a determining operation 1908. The determining operation 1908 determines whether the trace through flag is true or whether the hit count is greater than zero. If either the trace through flag (e.g., trace through checkbox 1237 in FIG. 12) is true or the hit count is greater than zero, the loop 1706 branches “yes” to a saving operation 1910. Similarly, if it is determined in the determining operation 1906 that the hit count is not equal to zero, the looping operation 1706 braches “no” to the saving operation 1910.

The saving operation 1910 saves the ray data temporarily so that the ray data can be used during the next iteration through the ray looping operation 1706. The ray data that is saved in the saving operation 1910 includes the ray location, ray direction, and ray number, in global coordinates, and is saved in the previous stage data array. The determining operation 1912 determines whether the ray is the last ray to be traced through the current stage. If the ray is the last ray to be traced, the looping operation 1706 branches “yes” to a saving operation 1914, wherein the ray number is saved from the previous stage. After the saving operation 1914, the ray looping operation ends at ending operation 1916. If the determining operation 1912 determines that the last ray has not been traced through this stage, the looping operation 1706 branches “no” to an incrementing operation 1918.

The incrementing operation 1918 increments the previous stage data array index to the next ray in the previous stage. The previous stage index is used when writing the ray data to the array that actually interacted with stage 1. A determining operation 1920 again determines whether the current stage is stage one. If the current stage is stage one, the looping operation 1706 branches “yes” to an incrementing operation 1922. The incrementing operation 1922 increments the ray counter to keep track of how many rays have been generated from the light source. Therefore, the previous stage is incremented regardless of stage number. A saving operation 1924 saves the ray number for use during the next iteration through the ray looping operation 1706. If in the determining operation 1920, it is determined the current stage is not stage one, the determining operation 1926 determines whether the hit counter equals zero. If it is determined that the hit counter is not zero, the looping operation 1706 branches “no” to the initializing operation 1802. Similarly, after the saving operation 1924, the looping operation 1706 branches to the initializing operation 1802.

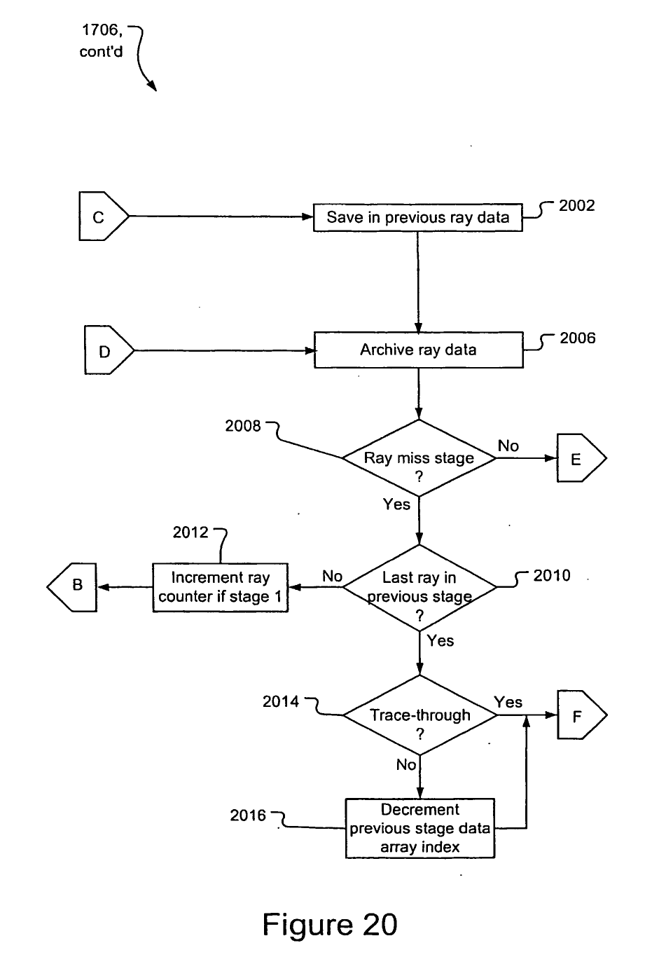

If it is determined in the determining operation 1908 that the hit counter is not greater than zero, or the trace through flag is false, the looping operation 1706 branches “no” to a saving operation 2002 (FIG. 20). Similarly, if in the determining operation 1926, it is determined that the hit counter equals zero, a “yes” branch is taken to the saving operation 2002, discussed in more detail below.

The ray looping operation 1706 continues as shown in FIG. 20. The saving operation 2002 saves the previous ray data so that it can be traced through to the next stage if necessary. This saving operation 2002 flags the ray as having missed the stage. Flagging the ray in one embodiment involves setting the element number equal to zero associated with the ray to indicate that “no” elements were hit by the ray. The ray number and its previous stage data, including location and direction, is temporarily saved using the current stage coordinates. After the saving operation 2002, an archiving operation 2006 archives the ray data, including the location, direction, ray number and element number.

The archiving operation 2006 saves the ray data in long-term memory so that it can be used during a subsequent trace starting at the current stage. For example, if the current stage is stage 3, the archived ray data will be made available in a subsequent ray-trace operations when the user wants to begin with stage three in the trace. The archiving operation 2006 may dynamically allocate memory if necessary to save the ray data. The ray data is stored using the stage coordinate system in this embodiment. The archiving operation 2006 increments a valid ray counter.

A determining operation determines if the ray missed the stage. The determining operation 2008 determines if the element number associated with the ray has been set equal to zero, and if so, the ray has missed the stage. If the ray misses the stage, the looping operation 1706 branches “yes” to a determining operation 2010. If the ray did not miss the stage, the looping operation 1706 branches “no” to an incrementing operation 2102 to be discussed below. The determining operation 2010 determines if the ray is the last ray in the previous stage. If the current ray is not the last ray in the previous stage, a “no” branch is taken to an incrementing operation 2012 wherein a ray counter is incremented if the current stage is stage one, to keep track of how many rays have been generated from the light source. After the incrementing operation 2012, the ray looping operation 1706 branches back to the initializing operation 1802.

If in the determining operation 2010 it is determined that the current ray is the last ray in the previous stage, the looping operation 1706 branches “yes” to a determining operation 2014. The determining operation 2014 tests the trace-through flag to determine whether the user has selected to have rays traced through the model even if they miss a stage. If the trace-through flag is not set to true, the looping operation 1706 branches “no” to a decrementing operation 2016. The decrementing operation 2016 decrements the previous stage data array index so that the previous ray that missed the current stage will not be traced through to the next stage in the next iteration. The decrementing operation 2016 eliminates the ray that missed the current stage from the analysis so that the ray will not be used in subsequent stages. After the decrementing operation and if it is determined that the trace-through flag is true, the looping operation branches to a saving operation 2132 discussed below.

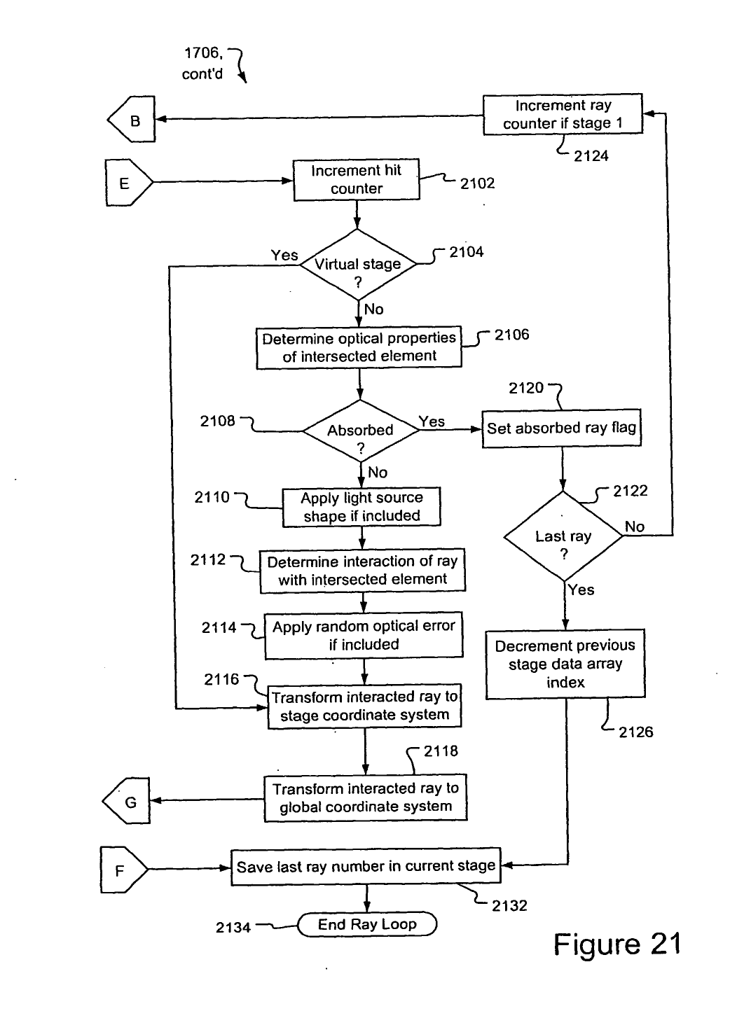

The ray looping operation 1706 continues as shown in FIG. 21. The incrementing operation 2102 increments the hit counter indicating that the current ray hit the current stage. After the incrementing operation, a determining operation determines whether the current stage is a virtual stage. The determining operation 2104 determines whether the current stage was defined as a virtual stage by the user in the stage/element geometry definition window 1200 shown in FIG. 12. If the current stage is not a virtual stage, the looping operation 1706 branches “no” to a determining operation 2106.

The determining operation 2106 determines which optical properties to use for the intersected element. For example, the determining operation 2106 determines whether the front or back side of the element has been hit, and selects the front or back side properties respectively. As is discussed in detail below, a back side hit flag is set if the back side of an element is hit by the ray. A determining operation 2108 determines whether the ray was absorbed by the element. As discussed with respect to the data structure 1304, a ray may be absorbed depending on the values in the reflectivity field 1318 or the transmissivity field 1302.

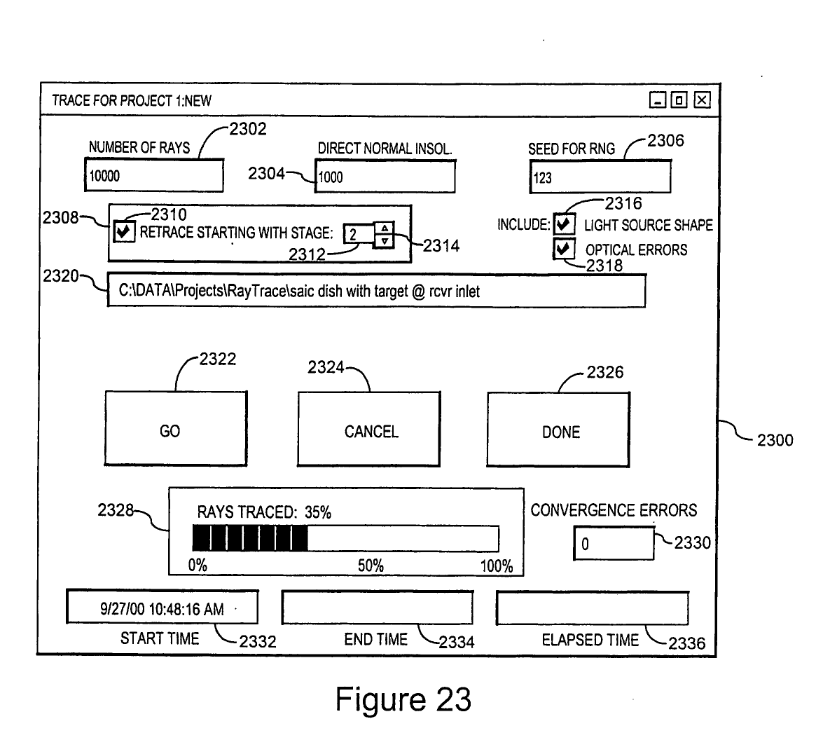

If it is determined that the ray was not absorbed by the element, the looping operation 1706 branches “no” to an applying operation 2110. The applying operation 2110 applies the light source shape if the current stage is stage one. Applying the light source shape involves using the frequency distribution associated with the light source to determine where on the light source the ray emanates from to determine a location and direction for the ray. A determining operation 2112 determines how the ray interacts with the intersected element. The determining operation 2112 uses the element properties discussed previously to determine the location of intersection and the angle of reflection or transmission through the element to determine a new direction for the ray. An applying operation 2114 applies the random optical error if included in the analysis (e.g., optical errors checkbox 2318 in FIG. 23.) After the random optical errors are applied in the applying operation 2114, a transforming operation 2116 transforms the ray to the current stage coordinate system.

Transforming the ray to the current stage coordinate system can be performed using equations (3) through (5) discussed above, or any other transformation algorithm known in the art. If in the determining operation 2104 it is determined that the current stage is a virtual stage, looping operation 1706 branches “yes” to the transforming operation 2116. Transforming operation 2118 transforms the ray from the current stage coordinate system to the global coordinate system. After the transforming operation 2118, the looping operation 1706 returns to the initializing operation 1816 to prepare for another iteration through the element loop 1820.

If the determining operation 2108 determines that the ray is absorbed by the element, the looping operation 1706 branches “yes” to a setting operation 2120 wherein a ray absorbed flag is set to true. A determining operation 2122 determines whether the ray is the last ray to be traced through the current stage. If the current ray is not the last ray to be traced through the current stage, the looping operation 1706 branches “no” to an incrementing operation 2124 wherein the ray counter is incremented if the current stage is stage one.

After the incrementing operation 2124, the looping operation returns to the initializing operation 1802 to begin another iteration through the ray looping operation 1706. If, on the other hand, the determining operation 2122 determines that the current ray is the last ray to be traced through the current stage, a decrementing operation 2126 decrements the previous stage data array index so that the previous ray is not used in a subsequent stage because the ray was absorbed in this stage. The saving operation 2132 saves the last ray number in the current stage for subsequent iterations through the looping operation 1706 and subsequent traces. The ray looping operation ends at ending operation 2134.

An embodiment of the element looping operation 1820 is illustrated in a flowchart shown in FIG. 22. The element looping operation 1820 begins with a determining operation 2202 wherein it is determined whether the current element has been selected by the user. The reader will recall that in the stage/element geometry definition window 1200, the user may select whether each element is turned on or off during a trace. If the current element is not selected for modeling, the element looping operation 1820 branches “no” to an incrementing operation 2204 wherein an element counter is incremented to refer to the next element.

A determining operation 2206 determines if the last element has been modeled based on the value of the element counter. If the last element has been modeled during the trace, the element looping operation branches “no” to the determining operation 2202. If the determining operation 2206 determines that the last element has been modeled, the element looping operation ends at an end operation 2208.

If in the determining operation 2202 it is determined that the current element is selected for modeling, the element looping operation 1820 branches “yes” to a transforming operation 2210. The transforming operation 2210 transforms the ray into the element coordinate system as defined in the stage/element definition window 1200. Transforming the ray into the current element coordinate system may be implemented using the equations (3) through (5) discussed above. An initializing operation 2212 initializes a backside-hit flag to false.

An optional adjusting operation 2214 adjusts the ray position by a small amount the ray's direction. The adjusting operation 2214 may be necessary to avoid computational numerical errors that may arise when the ray is retraced through the element looping operation 1820 to determine if the ray intersects with any other elements in the stage. It has been seen that in certain situations upon reiterating the element looping operation 1820 with a given ray, computational errors may arise if the position of the ray is not adjusted by a fraction. The adjustment is preferably extremely small and around 1×10⁻⁶ units.

A determining operation 2216 determines the intersection point of the ray with the surface of the current element, if any. The determining operation 2216 uses the starting location of the ray and the direction of the ray, in combination with the definition of the element surface provided in the stage/element definition window 1200, to determine where the ray will intersect the surface of the element. Any technique as is known in the art may be used to determine the intersection point on the surface of the element. One embodiment utilizes a Newton-Raphson iteration technique. Another embodiment may use a closed form solution to determine the intersection point. The determining operation 2216 also determines whether there is a back side hit on the surface of the element. If there is a back side hit on the element, the determining operation 2216 sets the back-side hit flag equal to true.

A determining operation determines if the ray intersected with the surface of the current element. If it is determined that the ray did not intersect with the surface of the current element, the looping operation 1820 braches “no” to the incrementing operation 2204. If the determining operation 2218 determines that the ray did intersect with the surface of the element, the looping operation 1820 branches “yes” to a determining operation 2220.

The determining operation 2220 determines whether the path length is less than previous path lengths. The determining operation 2220 determines whether the ray would hit the current element first as it travels from the light source or the previous stage to the current stage. If it is determined in the determining operation 2220 that the path length is not less than the previous path length, the ray would have hit the previous element first, and the element looping operation 1820 branches “no” to the incrementing operation 2204. If, on the other hand, the path length is determined to be less than the previous path length, the element looping operation 1820 branches “yes” to a determining operation 2222.

The determining operation 2222 determines whether the intersection point is within the aperture of the element. The determining operation 2222 utilizes the aperture geometry definition defined in the window 1200 by the user. Whether the intersection point is inside the aperture or not is primarily a function of the shape of the aperture and the location of intersection between the ray and the surface of the element. If the intersection point is not inside the aperture of the element, the element looping operation 1820 branches “no” to the incrementing operation 2204. If the intersection is within the aperture of the current element, the element looping operation 1820 branches “yes” to a setting operation 2224. The setting operation 2224 sets the stage-hit flag equal to true, indicating that the ray hit an element in its aperture in the current stage.

A saving operation 2226 saves ray data associated with the ray that intersected with the element. The saving operation 2226 saves the location, direction, ray number, and element number, in the element coordinate system. A transforming operation 2228 transforms the ray data into the current stage coordinate system. The transforming operation 2228 is performed so that the ray data is in the stage coordinate system for subsequent traces through the optical model. After the ray data is transformed into the stage coordinate system, the incrementing operation 2204 is entered to increment the element counter to the next element in the current stage, if any.

A user interface that may be used in conjunction with the executive trace operation 1500 (FIG. 15) is illustrated in FIG. 23. A trace activation window 2300 includes a number of visual display elements enabling a user to enter initialization data to initialize the trace, start the trace execution, stop the trace execution, and view trace execution statistics. A number of rays field 2302 enables the user to enter the number of rays to be generated from the light source. As shown in FIG. 23, 10,000 rays have been entered, but any number of rays may be entered.

A direct normal insolation (DNI) field 2304 enables the user to enter a direct normal insolation value representing a level of power per unit area on the light source. The direct normal insolation value selected by the user can be any value, but should be consistent with respect to units selected during the model definition steps discussed earlier. For example, the direct normal insolation value of 1,000 shown in FIG. 23 may represent 1,000 watts per square meter. In this case, the values entered in the global coordinates fields 1188, 1190, and 1192, will be in units of meters. As is shown in detail below, the DNI value entered in the direct normal insolation field 2304 may be used to generate power flux maps at physical and virtual stages defined in the optical model.

A seed field 2306 enables the user to enter a seed value for a random number generator (RNG) to randomly select numbers during the trace execution. For example, the seed value is used to randomly select a location on the light source using the light source shape previously defined. The seed value entered in the seed field 2306 is arbitrary and is used to initiate the random number generation process.

A starting stage selector 2308 enables the user to start the trace operation at a selected stage, including a stage other than stage one. A retrace checkbox 2310 may be selected by the user to indicate that the user wishes to select the starting stage. After the user selects the retrace checkbox 2310, a stage number field 2312 is activated to enable the user to enter the starting stage number desired. In one embodiment, starting stage selectable arrows 2314 are provided to offer the user a mechanism to increment and/or decrement the starting stage number. The starting stage selector 2308 may be activated after at least one trace of the model has been executed. The determining operation 1608, the activating operation 1610, and the selecting operation 1612, shown in FIG. 16, activate the starting stage selector 2308 after the first trace and allow the user to select a starting stage.

A light source shape checkbox 2316 is provided so the user can utilize a defined light source shape or alternatively not utilize a defined light source shape during the trace execution. If the light source shape checkbox 2316 is checked, the light source shape defined in the light source shape definition window 1100 will be used during the ray-trace operation. If the light source shape 2316 is not checked, the light source is assumed to be a point associated with rays that emanate from a point source light source during ray-trace operation. A point source light source does not have any angular deviation (i.e., parallel incoming rays). Thus, for example, a user is able to compare ray-trace execution results based on a point source, with the ray-trace results derived from a light source having some statistical distribution of angular deviation.

An optical errors checkbox 2318 is provided to enable the user to utilize predefined optical errors, or not utilize predefined optical errors during the trace execution. When the checkbox 2318 is checked, optical errors, such as the slope error and the specularity error defined in the data structure 1300 (FIG. 3), are used during the ray-trace operation. If the checkbox 2318 is not checked, predefined errors are not utilized during the ray-trace operation. The optical errors checkbox 2318 thus enables a user to turn on or off randomness due to optical errors. A data file field 2320 is provided to enable a user to enter a description of the model execution results obtained during the trace execution.

A start execution visual display element, such as a “go” button 2322, enables the user to begin ray-trace operation. When the user selects the go button 2322, the ray-trace execution begins using the defined model including the light source shape, the stage/element geometry, location, orientation, and properties, and the initialization data provided in the trace execution window 2300. The trace execution performs the operations described and depicted in FIGS. 15-22. Two types of stop visual display elements, such as a “cancel” button 2324, and a “done” button 2326, are provided to stop the trace execution. The cancel button 2324 when selected, cancels the trace execution without saving trace execution results. The done button 2326 when selected, exits the trace execution window 2300 after saving trace execution results. In a particular embodiment, the “done” button is only available after the trace has been completed.

After the go button 2322 is selected and during the ray-trace operation, ray-trace statistics may be dynamically updated in a number of fields, including a percentage traced field 2328, a convergence errors field 2330, a “start” time field 2332, and end time field 2334, and an elapsed time field 2336. The percentage traced field 2328 in one embodiment includes a percentage traced bar that increments as rays are traced during execution. After all the rays are traced, the “end” time field 2334 is updated with the end time associated with trace. The “elapsed” time field 2336 is updated with the difference between the end time field 2334 and the start time field 2332. During ray-trace execution, any errors that occur during the execution, are indicated in the convergence errors field 2330.

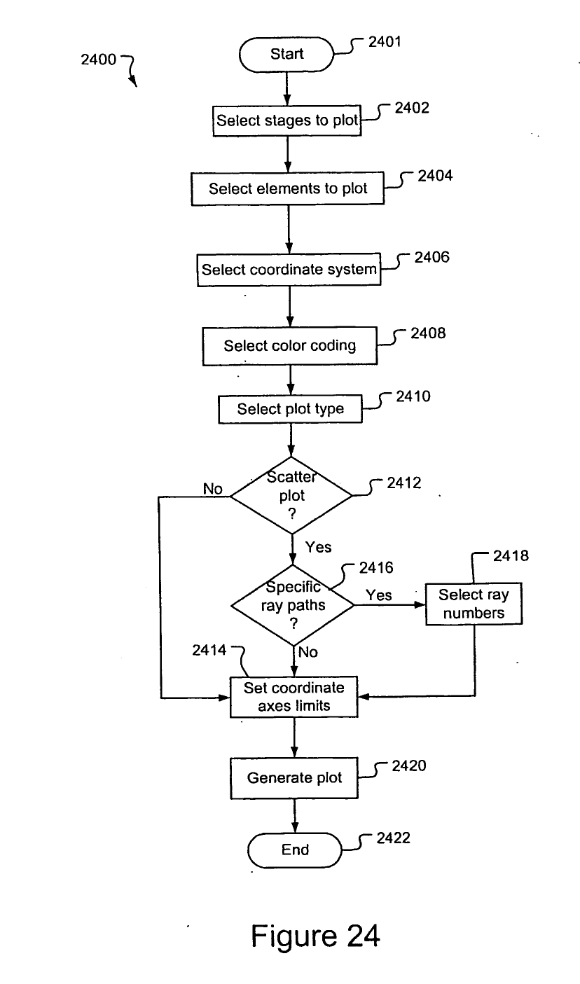

FIG. 24 is a flowchart illustrating a plotting operation that may be employed in an embodiment of the optics-modeling module 339 shown in FIG. 3. The plotting operation 2400 includes exemplary operations used to plot ray-trace data. Preferably the user can select among a number of plot formats, views, color-coding, etc. The plotting operation begins at starting operation 2401, and proceeds to a selecting operation 2402. In the selecting operation 2402, stages in the optical model are selected for plotting. In a selecting operation 2404, optical elements are selected to be included in the plot. In a selecting operation 2406, a coordinate system is selected for the plots. In a selecting operation 2408, color-coding is selected for the plots. In a selecting operation 2410, the type of plot is selected.

A determining operation 2412 determines what type of plot was selected in the selecting operation 2410. If the selected plot is not a scatter plot, the plotting operation 2400 branches “no” to a setting operation 2414. If the type of plot selected in the selecting operation 2410 is a scatter plot, the plotting operation 2400 branches “yes” to a determining operation 2416. In the determining operation 2416, it is determined whether the user has selected to have specific ray paths plotted. If the user has not selected to have specific ray paths plotted, the plotting operation 2400 branches “no” to the setting operation 2414. If the user has selected to have specific ray paths plotted, the plotting operation 2400 branches “yes” to a selecting operation 2418. In the selecting operation 2418, specific ray paths are selected to be plotted. In one embodiment of the selecting operation 2418, rays are selected by corresponding ray numbers.

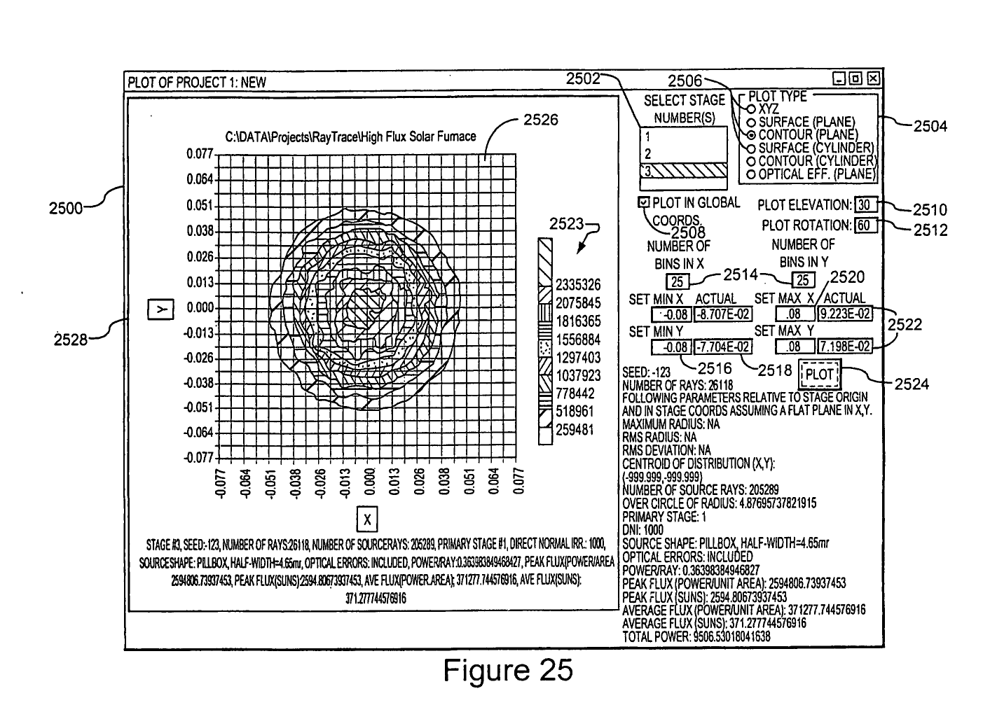

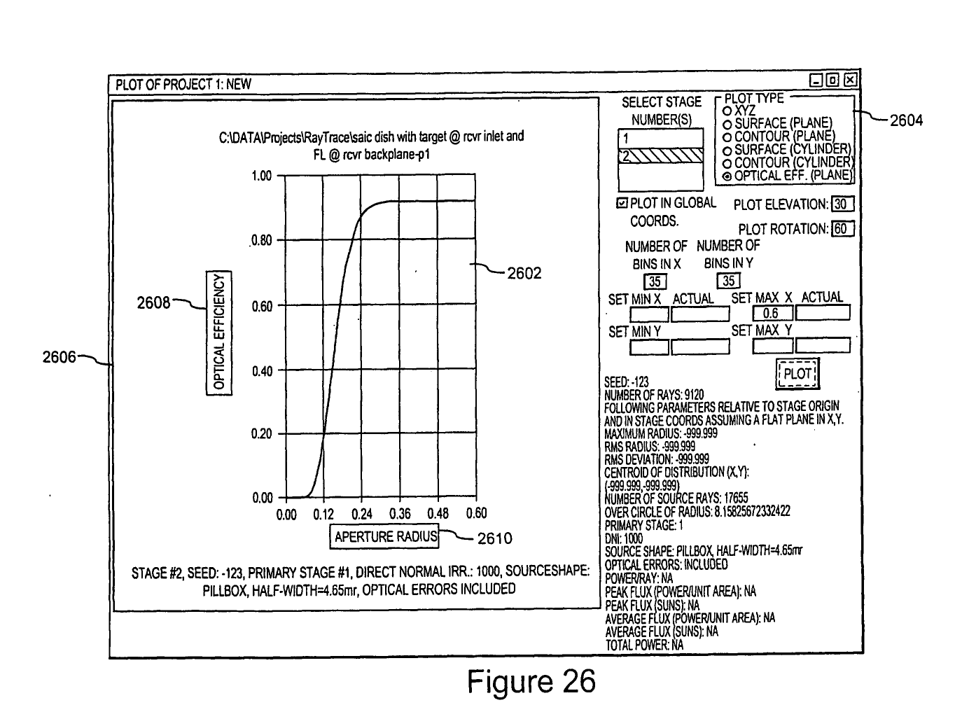

After the selecting operation 2418, the setting operation 2414 sets the coordinate axes. The coordinate axes limits are set in the setting operation 2414 based on the minimum and maximum “x, y, z” values for all the rays stored during the ray-trace execution. Also in the setting operation 2414, the user may adjust the coordinate axes limits to adjust the appearance of the plot. Based on all the selections previously made, a generating operation 2420 generates the plot on the computer monitor 391 (FIG. 3). The plot that may then be printed on a printer such as the printer 396 (FIG. 3). The plotting operation 2400 ends at ending operation 2422. The plotting operation 2400 is executed in conjunction with one or more user interfaces provided to the user to make the selections for plotting and generating the plot according to the selections. Exemplary graphical user interfaces (GUIs) are illustrated in FIGS. 25 and 26.

FIG. 25 illustrates a user interface that may be used in conjunction with the plotting operation shown in FIG. 24. A plotting user interface, such as the plotting window 2500, enables the user to select a number of options related to plotting ray-trace results data, and present to the user data related to the optical model that was traced. A stage selector 2502 presents the stage numbers to the user and enables the user to select one or more of the stage numbers for plotting. Ray interaction will be plotted for the stage or stages that are selected in the stage number selector 2502. A plot type selector 2504 presents a number of types of plots to the user and enables the user to select among the types of plots. The plot type selector 2504 provides visual display elements, such as plot type radio buttons 2506, which enable the user to select one of the plot types. In the embodiment shown, the user may select an “x, y, z” plot, a planar surface plot, a planar contour plot, a cylindrical surface plot, a cylindrical contour plot, or an optical efficiency plot. As shown, the radio button 2506 has been selected for the planar contour plot. Other types of plots may be used in other embodiments, without departing from the scope of the present invention.

A global coordinates selector, such as the global coordinates checkbox 2508, enables the user to plot using global coordinates. A plot elevation field 2510 enables the user to select an elevation value, which designates a level of zooming with respect to the plot that is displayed. In other words, the elevation field 2510 designates a perceived closeness to the plot. A plot rotation field 2512 enables the user to designate a level of rotation of the plot that is shown. In the embodiment illustrated, the elevation and rotation fields are entered in units of degrees. Granularity fields 2514 enables the user to specify levels of granularity in the plot in the “x and y” directions.

Axes minimum entry fields 2516 enable the user to enter minimum values for the “x and y” axes respectively. Actual minimum fields 2518 present the minimum values in the “x and y” directions respectively. Axes maximum entry fields 2520 enable the user to specify maximum axes limits in the “x and y” directions respectively. Actual maximum fields 2522 present the actual maximum “x and y” values. A plot display element, such as the plot button 2524, enables the user to a plot ray-trace data based on the selections made in the stage selector 2502, the plot type selector 2504, the global coordinates checkbox 2508, the elevation field 2510, the rotation field 2512, the granularity fields 2514, the axes minimum fields 2516, the axes maximum fields 2520.

After the plot button 2524 is selected, a plot 2526 of the ray-trace results data is displayed in a plot frame 2528. In the embodiment shown in FIG. 25, a planar contour plot type was selected. Therefore, a plot 2526 is a planar flux map showing the contour of power flux through the selected stage. A power flux legend 2530 presents ranges of power flux shown in different colors. The ranges shown in the power flux legend 2523 are based on the number of rays traced and saved in the results data, the number of rays intersecting the selected stage, and the power per unit area designated by the direct normal insolation (DNI) value (chosen in field 2304 in FIG. 23). The power flux ranges are also a function of the area of the light source circle encompassing stage 1 as described earlier.

FIG. 26 illustrates another embodiment of a user interface that may be used in conjunction with the plotting operation shown in FIG. 24. A planar optical efficiency plot 2602 has been selected in the plot type selector 2604 and is displayed in the plot frame 2606. The optical efficiency plot 2602 shows optical efficiency 2608 on the “y” axis as a function of aperture radius 2610 on the “x” axis. In one embodiment, the user has the ability to rotate and manipulate a plot via an input device, such as the mouse (mouse 361 in FIG. 3). If the user clicks the right mouse button while the mouse selection element (e.g., pointer arrow) is over the plot, a menu is activated which allows the user to edit plot features. By clicking the left mouse button when the pointer arrow is over the plot and dragging the mouse, the plot is rotated in the direction of the mouse drag.

In another embodiment (not shown) individual rays that were traced during trace execution may be plotted. In this embodiment, the rays are numbered, and the user may select particular ray numbers to be plotted. When rays are selected for plotting, ray paths are illustrated with arrows depicting the paths of the selected rays. The ray paths may be plotted in a variety of colors to distinguish them from elements and stages. When the user moves the mouse pointer arrow over a plotted ray, a pop-up window is displayed with ray information including, but not limited to, ray number and location.

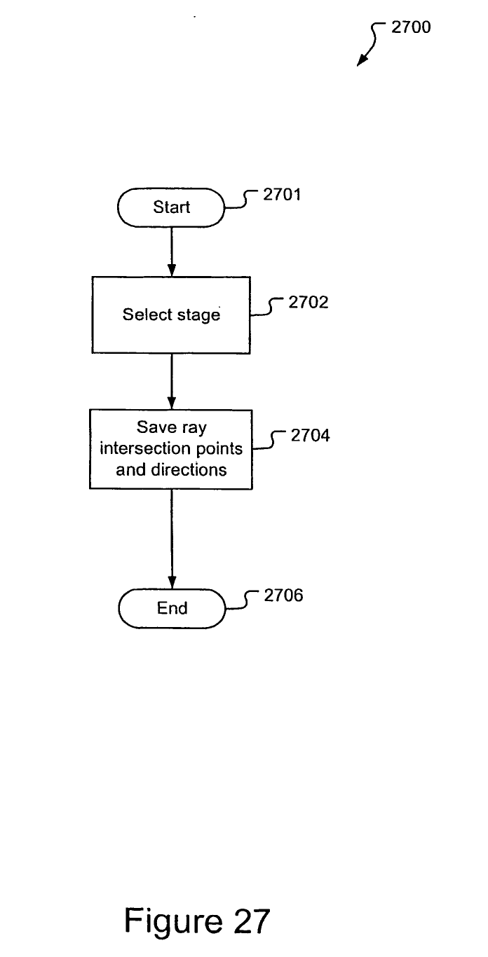

FIG. 27 is a flowchart illustrating an embodiment of the saving operation 512 shown in FIG. 5. The saving operation 2700 illustrates a process in accordance with an embodiment of the present invention for saving ray-trace results. After a starting operation 2701, a selecting operation 2702 selects one or more stages of the optical model. A saving operation saves ray interception points, locations, and directions associated with ray interception of the selected stage or stages. The saving operation 2704 saves the ray data in a suitable format on memory media in the computer system 300 (FIG. 3) whereby the micro-processor 320 may read the ray data out of memory during a subsequent ray-trace or plotting. The saving operation ends at ending operation 2706.

The method steps illustrated in FIGS. 5, 7-10, 15-22, 24, and 27 may be implemented in firm ware in the disc drive or in a computer connected to a disc drive. Additionally, the logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

What is claimed is:

1. A method of modeling an optical system comprising a light source and an optical device operable to interact with rays from the light source, the method comprising:
defining a frequency distribution relating a location on the light source with a probability that a ray will emanate from the location; and
using the frequency distribution to simulate interaction of rays from the light source with the optical device.

2. The method of claim 1 further comprising:
defining a light source model representing the light source;
defining an optical device model representing the optical device; and
predicting interaction of a first modeled ray from the light source with the optical device using the light source model and the optical device model, the modeled ray having one or more ray parameters.

3. The method of claim 2 further comprising:
generating simulation data representing interaction of the first modeled ray with the optical device; and
analyzing the simulation data.

4. The method of claim 2 wherein defining an optical device model comprises:
defining a first optical stage of the optical device model; and
defining an optical element of the optical stage.

5. The method of claim 3 wherein analyzing the simulation data comprises:
instantiating a first modeled ray from a location on the light source model based on the frequency distribution; and
determining a location on the optical element of the first stage at which the first modeled ray intersects the optical device model.

6. The method of claim 3 wherein analyzing the simulation data further comprises:
determining an angle of reflection determining a resultant direction of the first modeled ray caused by interaction of the ray with the optical element.

7. The method of claim 2 wherein the optical device comprises an optical stage having an optical element, and wherein defining the optical device model comprises:
defining optical stage model parameters characterizing the optical stage; and
defining optical element model parameters characterizing the optical element.

8. The method of claim 5 wherein defining the optical stage model parameters comprises:
defining a stage position;
defining a stage orientation; and
designating the optical stage as a virtual stage or an actual stage.

9. The method of claim 6 wherein defining the optical stage model parameters comprises:
inputting optical stage parameter data from a file containing optical stage parameter data.

10. The method of claim 7 further comprising designating the optical stage as traced-through.

11. The method of claim 2 wherein the ray parameters comprise:
a location attribute; and
a direction attribute.

12. The method of claim 3 wherein defining the optical element comprises:
defining an element geometry descriptor;
defining an surface descriptor; and
defining a surface type descriptor.

13. The method of claim 3 wherein defining the optical element comprises:
incorporating measured surface data associated with an existing optical element.

14. The method of claim 11 wherein the measured surface data comprises Video Scanning Hartmann Optical Test data.

15. Method of claim 1 wherein the using step comprises employing a Monte Carlo simulation.

16. Method of claim 5 wherein the optical element comprises a front surface and a back surface and defining an optical element further comprises:
defining front surface description data; and
defining back surface description data.

17. The method of claim 11 wherein the measured surface data comprises:
a surface type descriptor;
geometry descriptor data; and
surface error descriptor data.

18. The method of claim 17 wherein the surface type descriptor comprises at least one of hemisphere, parabola, flat, conical, hyperboloid, ellipsoid, general, zernike, and Video Scanning Hartmann Optical Tester (VSHOT).

19. The method of claim 17 wherein the geometry descriptor data comprises:
an X origin;
a Y origin;
a Z origin; and
a Z rotation.

20. The method of claim 17 wherein the surface error descriptor data comprises at least one of slope error and specularity error.

21. The method of claim 3 wherein analyzing comprises:
plotting the first modeled ray on a graphical plot.

22. The method of claim 3 further comprising:
generating a second modeled ray from the light source model based on the distribution;
determining whether the second ray will impact the optical element based on the attributes in the second modeled ray; and
if the second ray will impact the optical element, updating the attributes of the second modeled ray based upon the element profile and the attributes of the second modeled ray.

23. The method of claim 20 further comprising:
repeating the generating, determining, and updating steps for a plurality of modeled rays; and
generating ray distribution data based on locations of ray impact on the optical element.

24. The method of claim 21 further comprising:
plotting the ray distribution data.

25. The method of claim 22 wherein the plotting comprises:
generating a planar contour plot.

26. The method of claim 22 wherein the plotting comprises:
generating a surface cylinder plot.

27. The method of claim 22 wherein the plotting comprises:
generating a planar surface plot.

28. The method of claim 22 wherein the plotting comprises:
generating a cylindrical contour plot.

29. The method of claim 22 wherein the plotting comprises:
generating an optical efficiency plot.

30. A method of modeling a photon trace upon a solar receptor having a plurality of optical elements at a plurality of positions on the solar receptor comprising:
defining a shape of the dispersed light source;
defining a profile for each of the optical elements;
choosing a photon from the dispersed light source;
selecting a point on the solar receptor;
determining if one of the optical elements is positioned at the selected point; and
if “no” optical element is positioned at the selected point, choosing another point on the solar receptor.

31. The method of claim 30 wherein defining the shape of the dispersed light source comprises:
creating a model of the dispersed light source based on measured data.

32. The method of claim 30 further comprising:
if a first optical element is positioned at the selected point, determining an angle of reflection of the photon from the first optical element;
generating a trajectory based on the angle of reflection;
determining if the photon impacts a second optical element based on the trajectory and position of the second optical element; and
if the photon impacts the second optical element based, marking the photon as expired.

33. The method of claim 30 further comprising:
defining a plurality of stages, wherein each stage includes a plurality of optical elements.

34. The method of claim 32 further comprising:
repeating all steps for each of the plurality of photons; and
aggregating results for all photons.

35. In a computer system having a display and a pointer device, a method of identifying errors in an optical element comprising:
modeling a trace of a plurality of photons received by the optical element;
capturing a plurality of photon data characterizing an associated plurality of photon characteristics at a plurality of stages in the trace; and
displaying a graphical trace of the plurality of photons.

36. The method as recited in claim 35 wherein the graphical trace is displayed on a graphical user interface, the method further comprising:
determining if the pointer device is positioned over a selected photon; and
if the pointer is positioned over the selected photon, displaying a drop-down box including a photon number.

37. The method as recited in claim 36 wherein displaying further comprises:
in response to selecting the photon, displaying on the graphical trace only the selected photon.

38. The method as recited in claim 35 wherein modeling comprises:
inputting experimentally measured data characterizing an existing optical device.

39. The method as recited in claim 38 wherein the experimentally measured data comprises Video Scanning Hartmann Optical Tester data.

40. The method as recited in claim 35 wherein the optical element is in a first stage and modeled results characterize a second stage, the method further comprising:
comparing modeled results with expected results;
if modeled results do not match expected results, generating a virtual surface at the first stage; and
utilizing the virtual surface to detect spurious photon reflections.

41. A method of modeling a ray-trace through a plurality of stages comprising:
defining a stage profile for each of the plurality of stages;
projecting a ray upon the plurality of stages; and
determining if the ray expires before reaching the last stage.

42. The method of claim 41 wherein defining a stage profile comprises:
defining a global coordinate system;
locating a stage coordinate system in terms of the global coordinate system; and
orienting the stage coordinate system within the global coordinate system.

43. The method of claim 41 wherein defining a stage profile comprises:
inputting measured data characterizing each of the plurality of stages.

44. The method of claim 42 further comprising:
designating one or more of the plurality of stages as a virtual stage; and
defining a virtual surface for the virtual stage.

45. The method of claim 44 further comprising:
capturing a plurality of ray intersection points on the virtual stage; and
plotting the plurality of ray intersection points.

46. A method of modeling an optical system including a light source emitting a plurality of rays and a stage including at least one optical element, comprising:
defining a stage coordinate system relative to a global coordinate system, representing the orientation of the stage within the global coordinate system;
defining a light source shape representing a frequency distribution of rays from locations on the light source;
defining a location of the light source in the global coordinate system;
defining an element coordinate system for each of the at least one optical elements, representing the orientation of the at least one optical elements within the stage coordinate system;
generating a ray object representing one of plurality of rays, the ray object having a location and a direction in the global coordinate system; and
determining whether the one of the plurality of rays meets one of the at least one of the optical elements based on the location and direction of the ray object and the element coordinate system of the one of the at least one of the optical elements.

47. The method of claim 46 further comprising:
if the one of the plurality of rays meets the one of the at least one optical elements, determining an effect upon the one of the plurality of rays in response to meeting the one of the at least one of the optical elements.

48. The method of claim 46 wherein the determining operation comprises:
determining a location and angle of departure of the one of the plurality of rays from the light source based upon the light source shape;
determining a location and angle of impact of the one of the plurality of rays upon the at least one of the optical elements;
determining a location and angle of departure of the one of the plurality of rays from the at least one of the optical elements.

49. A modeling system operable to model in optical system having a light source, an optical element having a front and back surface, each of the surfaces having optical properties, the modeling system comprising:
a model creation module operable to create an optical model of the optic system;
memory holding a data structure representing the optical properties of the front element and the optical properties of the back element, the memory receiving the data structure from the model creation module; and
a model execution module in operable communication with the memory operable to read the data structure and trace a ray from the light source to the element based on the front and the back optical properties stored in the data structure.

50. The optics modeling system of claim 49 wherein the data structure comprises:
an optical surface number representing the front or back surface of the optical element;
two indices of refraction representing real and imaginary components of refraction associated with the front or back surface;
an aperture stop field representing an aperture type of the optical element;
a diffraction order field representing a level of diffraction of the front or back surface;
a plurality of grating spacing polynomial coefficients;
a reflectivity field;
a transmissivity field;
a root mean square slope error;
a root mean square specularity error; and
a distribution type representing a frequency distribution associated with the front or back surface.

51. The optics modeling system of claim 50 wherein the distribution type in the data structure is selected from the group consisting of Gaussian and pillbox.

52. The optics modeling system of claim 49 wherein the model execution module is further operable to determine an angle of departure associated with the ray from the front surface based on front surface properties in the data structure, and determine whether the ray will impact the back surface based on the angle of departure.

53. A computer comprising:
a memory;
a processor;
a display;
an application stored in memory and executable on the processor, the application presenting on the display a graphical user interface having an model stage type selection frame presenting selectable model stage types; and
the application being configured to accept a user-selected model stage type selected from the model stage types and performs a ray-trace operation based on the user-selected model stage type.

54. The computer as recited in claim 53 wherein the selectable model stage types comprise a virtual stage and an optical stage.

55. The computer as recited in claim 54 wherein the graphical user interface further comprises:
a stage count entry field operable to accept a number representing a number of model stages to be modeled in the ray-trace operation; and
a selectable stage tab operable to display a data entry table, the stage tab corresponding to the model stage associated with the one of the element data entry tables.

56. The computer as recited in claim 55 further comprising a plurality of element data entry tables, each element data entry table operative to accept optical element definition data for each of the one or more optical elements of the associated model stage.

57. The computer as recited in claim 56 wherein each of the plurality of element data tables comprises:
a list of element numbers, each element number corresponding to one of the one or more optical elements; and
an element selector associated with each of the plurality of element numbers, the element selector operable to select or deselect an optical element for inclusion in a ray-trace operation.

58. The computer as recited in claim 56 wherein the GUI further comprises a trace-through selector operable to set a trace-through flag designating that rays that miss one or more stages during the ray-trace operation and continue to be traced through all stages.

59. A graphical user interface to facilitate entry of an optics system model comprising:
a light source shape definition window whereby a light source may be defined;
a stage/element definition window whereby one or more stages of an optical device may be defined;
a trace execution window whereby a ray-trace may be executed to gather ray trace data representing rays from the light source interacting with the one or more stages; and
a plot window whereby the ray trace data may be plotted.

60. The graphical user interface of claim 59 wherein the stage/element definition window further comprises:
an optical element data entry pane wherein one or more optical elements associated with the one or more stages may be defined.

61. The graphical user interface of claim 60 wherein the optical element data entry pane comprises:
one or more selectors each associated with one of the one or more optical elements, whereby each defined optical element may be selected for ray tracing or deselected.

62. The graphical user interface of claim 61 wherein the optical element data entry pane further comprises:
a stage selector tab for each of the one or more stages, each stage tab selecting an optical element data entry pane associated with the stage.

63. The graphical user interface of claim 59 wherein the stage/element definition window comprises a trace-through selection element whereby each stage may be designated to be traced through during trace execution.

64. The graphical user interface of claim 59 wherein the stage/element definition window comprises a virtual stage selection element whereby each stage may be designated as a virtual stage.

65. A computer readable medium having computer executable instructions representing an optical system modeling application capable of performing the steps of:
defining a light source model representing the light source, the light source model including a boundary and a frequency distribution relating a probability to a location within a boundary of the light source model;
defining an optical device model representing the optical device; and
analyzing interaction of a first modeled ray from the light source model with the optical device model, the modeled ray having one or more ray parameter(s).

66. The computer readable medium of claim 65 wherein defining an optical device model comprises:
defining a first optical stage of the optical device model; and
defining an optical element of the optical stage.

67. The computer readable medium of claim 66 wherein analyzing comprises:
generating a first modeled ray from a location on the light source model based on the frequency distribution; and
determining a location on the optical element of the first stage at which the first modeled ray intersects the optical device model.

68. The computer readable medium of claim 67 wherein analyzing further comprises:
determining an angle of reflection from the optical element at which the first modeled ray reflects from the optical element.

69. The computer readable medium of claim 65 wherein the optical device comprises an optical stage having an optical element, and wherein defining the optical device model comprises:
defining optical stage model parameters characterizing the optical stage; and
defining optical element model parameters characterizing the optical element.

70. The computer readable medium of claim 69 wherein defining the optical stage model parameters comprises:
defining a stage position;
defining a stage orientation; and
designating the optical stage as a virtual stage or an actual stage.

71. The computer readable medium of claim 70 wherein defining the optical stage model parameters comprises:
inputting optical stage parameter data from a file containing optical stage parameter data.

72. The computer readable medium of claim 71 further comprising designating the optical stage as traced-through.

73. The computer readable medium of claim 65 wherein the ray parameters comprise:
a location attribute; and
a direction attribute.

74. The computer readable medium of claim 66 wherein defining the optical element comprises:
defining an element geometry descriptor;
defining an surface descriptor; and
defining a surface type descriptor.
